(19) United States
(12) Patent Application Publication
(10) Pub. No.: US 2008/0263080 A1
(43) Pub. Date: Oct. 23, 2008

(54) GROUP VISUALIZATION SYSTEM AND SENSOR-NETWORK SYSTEM

(76) Inventors: Shinichi FUKUMA, Tokyo (JP); Rieko Otsuka, Fuchu (JP); Kazuo Yano, Hino (JP); Takeshi Hoshino, Kodaira (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/105,500

(22) Filed: Apr. 18, 2008

(30) Foreign Application Priority Data
Apr. 20, 2007 (JP) 2007-111196
Jun. 21, 2007 (JP) 2007-163300

(51) Int. Cl. G06F 17/30

(52) U.S. Cl. 707/102; 707/100; 707/E17.044

(57) ABSTRACT

A group visualization system generates a tree structure having a hierachical structure by arranging data built up by a sensor network using small nameplates and further generates an organization topographical diagram expressing group dynamics from the tree structure. True roles of persons and true groups that have not appeared so far in existing organization diagrams can be readily obtained.

### INCORPORATION BY REFERENCE

The present application claims priorities from Japanese applications JP2007-111196 filed on Apr. 20, 2007, and JP2007-163300 filed on Jun. 21, 2007, the contents of which are hereby incorporated by reference into this application.

### BACKGROUND OF THE INVENTION

1. Field of the Invention

This invention relates to a group visualization system for constituting a business microscope system using a sensor network technology, and more particularly to an analysis system for analyzing group dynamics of people and a sensor network system including a display system for displaying the result of analysis.

2. Description of the Related Art

Technology of a sensor network system for measuring conditions of articles, people or environment by small terminals called “sensor nodes” equipped with a sensor, a wireless communication function and a driving power source and connecting the sensor nodes by a network is known (refer to a non-patent document 1, “Development of Sensor Net Terminal Having Cell Life of One Year or More and the Smallest Capacity in the World”, Nov. 24, 2004, retrieved on Apr. 16, 2007, Internet at URL: http://www.hitachi.co.jp/New/cnews/month/2004/11/1124 html, News Release of YRP Ubiquitous Networking Research Institute; Hitachi, Ltd., for example).

A technological attempt has also been made in the past to visualize friend relations in a graph form so that a social network constituted by the friends can be grasped from a higher level (for example, refer to a non-patent document 2; Ken Wakita, “Complex System, Vizster”, Feb. 2, 2002, retrieved on Apr. 16, 2007, Internet at URL: http://d.hatena.ne.jp/kwakita/20070202).

One of the known methods for displaying a database includes the method that displays arbitrary data having only an “including/included relation” (hierachical structure) inside the database as an object in a three-dimensional space (for example, refer to a patent document 1, JP-A-10-312392).

Furthermore, a technology that stores a parent-child relation among various kinds of information together with position time series information and outputs a relational diagram displaying the linkage between a relational map displaying the transition of the relation along the position time series of various kinds of information and the various kinds of information by link is known (for example, refer to a patent document 2, US2002/0107859A1).

### SUMMARY OF THE INVENTION

Improvement of productivity is an essential theme for all kinds of organizations and a large number of trials and errors have been made in the past to improve office environment and business efficiency. In the limited case of business organizations for assembly or transportation such as plants, for example, performances can be objectively analyzed by tracking the moving path of components or products. As for white color organizations for carrying out knowledge industry such as business affairs, sales and planning, “hardware” and business are not directly associated with each other. Therefore, the organizations cannot be evaluated by observing the hardware. An original aim of forming an organization is to accomplish a large-scale business that a single person cannot achieve, through cooperation of a plurality of persons. Consequently, decision and mutual consent are always made by two or more persons in all kinds of the organizations. It is possible in this case to consider that decision and mutual consent is governed by a relationship among the persons and eventually, productivity is governed by this decision and mutual consent. Therefore, the relationship may be those which are labeled as a superior-subordinate relation or a friend relation or may contain various human emotions and sentiments such as good will, disgust, reliance, influences, and so forth. Mutual understanding or in other words, communication, is indispensable for persons to establish relationship with others. Relationship can be examined presumably by acquiring records of communication.

One of the methods for detecting the communication between the persons utilizes a sensor network. The sensor network is the technology that fits a terminal having a sensor and a wireless communication circuit to an environment, an article or a person, picks up various kinds of information acquired from the sensors through wireless communication and applies the information for acquisition and control of the condition as described in the afore-mentioned non-patent document 1. The physical value acquired by the sensor for detecting the communication between the persons includes IR (infrared rays) for detecting a meeting condition, voice for detecting speech and environment and acceleration for detecting operations of a person.

A business microscope system is the one that detects motion of persons and communication among the persons from the physical values acquired from the sensors, visualizes the condition of the organization and helps improve the organization.

The technology of the sensor network has already brought forth addition values by continuously supervising the environment which is out of an easy access of people besides the reduction of cost in factories through quality management and entrance/exist management, for example. Nonetheless, consciousness investigation and interviews have still been dominant as means for looking into dynamic roles and activities of persons in organizations (group dynamics) and attempts have been made to analyze and display communication on a network as disclosed in the afore-mentioned non-patent document 2.

Incidentally, people in organizations (groups, companies, etc, in which they work together with a common object) are generally defined and managed by “organization diagrams” determined by top officials of the organization. Various representation and analyses of the “organization diagram” have been attempted in the past as described in the afore-mentioned patent document 1.

However, the activity of people, or a person, in an organization is not limited to the one set forth in the organization diagram. Though a certain person has one post on the organization diagram, the person holds intercourses with various others, works or discusses with others and has a plurality of roles as a constituent member of the organization. In such a case, an “organization diagram representing behaviors and relations of persons” capable of representing “true roles” and “true groups” of persons exists separately from the organization diagram of the prior art but such a diagram cannot be known readily at present. The technology described in the afore-mentioned patent document 1 can be said as one of the means for expressing more easily the organization that is recognized as a clear entity by the constituent members and managers of the organization. In other words, it is the technology to represent once again the “existing organization diagram” in a more apprehensible way. Consequently, this technology does not aim at expressing the “roles” and “group” as the entity that exist only latently and cannot be expressed by the “existing organization diagram”.

A plurality of database management systems for managing the information representing what relation each person has with which persons and for retrieving and perusing the database has been studied in the past as described in the patent document 2 but their object is limited to the “existing organization diagram” as known past information. Therefore, these studies cannot acquire and display the “roles” and “groups” as the entity existing only latently in the form of “organization diagram representing behaviors and relations of persons”.

To visualize such an “organization diagram representing behaviors and relations of persons”, known means that dynamically analyzes and displays relation diagrams in blogs and social networks exist. Though these means can express with which persons a given person has relations but cannot yet express “true roles” and “true groups” because they are hidden by numerous relations.

It is an object of the invention to dynamically analyze and derive an “organization diagram representing behaviors and relations of persons” that have not appeared in the organization diagrams of the prior art, by a business microscope and to express the diagram in a more comprehensible and more characterizing way.

A typical and concrete example of the invention is as follows. A group visualization system according to the invention has a sensor network including a plurality of sensor nodes corresponding to a plurality of persons constituting an organization on the 1:1 basis; and an analyzing unit for analyzing a relation among these persons from a physical value of each of the persons detected by the sensor network; wherein unknown groups in the organization are extracted from the relations of the plurality of persons and the unknown groups so extracted are visualized.

A sensor network system according to the invention has an organization dynamics data acquiring unit including a plurality of sensor nodes having sensors mounted thereto and corresponding to a plurality of persons constituting an organization on the 1:1 basis, acquiring a physical value detected by each of the sensor nodes as data about the plurality of persons and wireless transmitting the data acquired; a performance inputting unit for inputting performance of each of the plurality of persons to the organization on the basis of a predetermined reference; an organization dynamics data collecting unit for collecting the data and the performance outputted respectively from the organization dynamics acquiring unit and the performance inputting unit and storing them as a data table and a performance data table, respectively; a mutual data aligning unit for inputting data about two arbitrary persons among the plurality of persons from the organization dynamics data collecting unit and mutually aligning two sets of data inputted on the basis of time information; a correlation coefficient studying unit for calculating feature values about the two persons on the basis of the two sets of data inputted from the mutual data aligning unit, calculating an organization feature value as a feature value of the organization on the basis of mutual correlation of the two persons calculated from the pair of the feature values, acquiring organization performance as performance of the organization on the basis of an output from performance database, and analyzing the correlation between the organization feature value and the organization performance and deciding a coefficient of correlation; an organization activity analyzing unit for acquiring the coefficient of correlation from the correlation coefficient studying unit, outputting an estimation value of the organization performance on the basis of the coefficient of correlation acquired, calculating the coefficient of correlation of the two persons on the basis of the two sets of data inputted from the mutual data aligning unit; a grouping unit for judging whether or not the pair of the two persons constitutes a group on the basis of the data about the distance; and an organization activity displaying unit for displaying the group in the form reflecting the distance when the two persons constitute a common group on the basis of the judgment result of the grouping unit.

According to the invention, it becomes possible to grasp original roles of an individual and groups that are different from the organization diagrams and roles stipulated, have been latent and have not been able to grasp positively, and to apply them to management of the business site.

To solve the problems described above, the invention provides an analysis/display method of group dynamics that attaches a small sensor based on a sensor network to each person, analyzes large quantities of data dynamically stored and derives “true roles” of persons and “true groups” in an organization.

The invention provides also a display method that converts and creates the data built up into a tree structure as a matrix M and further creates an organization topographical diagram C from the tree structure and visualizes the data so that everyone can intuitively understand.

Still another feature of the invention is to display “vigorousness of action” of an individual wearing a sensor terminal.

Other objects, features and advantages of the invention will become apparent from the following description of the embodiments of the invention taken in conjunction with the accompanying drawings.

### BRIEF DESCRIPTION OF THE DRAWINGS

FIG. 1 shows an example of a screen that uses the invention;

FIG. 2 shows an existing organization diagram;

FIG. 3 shows a synchronous group to be formed;

FIG. 4 shows groups of the same project to be formed;

FIG. 5 shows an example when the same person belongs to a plurality of groups;

FIG. 6A shows an example when the group on an organization diagram appears;

FIG. 6B shows an example when the group on the organization diagram does not appear;

FIGS. 7A to 7D show the overall flow of a processing executed in a business microscope system;

FIGS. 8A to 8D are explanatory views for explaining the construction of a nameplate type sensor node representing an embodiment of the invention in a block diagram of an overall business microscope system;

FIG. 9A is a top view showing the appearance of a business microscope nameplate type sensor node;

FIG. 9B is a front view showing the appearance of the business microscope nameplate type sensor node;

FIG. 9C is a bottom view showing the appearance of the business microscope nameplate type sensor node;

FIG. 9D is a rear view showing the appearance of the business microscope nameplate type sensor node;

FIG. 9E is a side view showing the appearance of the business microscope nameplate type sensor node;

FIG. 11A is an explanatory view showing an arrangement relation of infrared transceiver modules when two persons communicate with each other while facing each other;

FIG. 10B is an explanatory view showing an arrangement relation of the infrared transceiver modules when a standing person and a person sitting on a chair communicate with each other;

FIG. 10C is an explanatory view for explaining an infrared transceiver module having an infrared transceiver unit arranged with a certain angle;

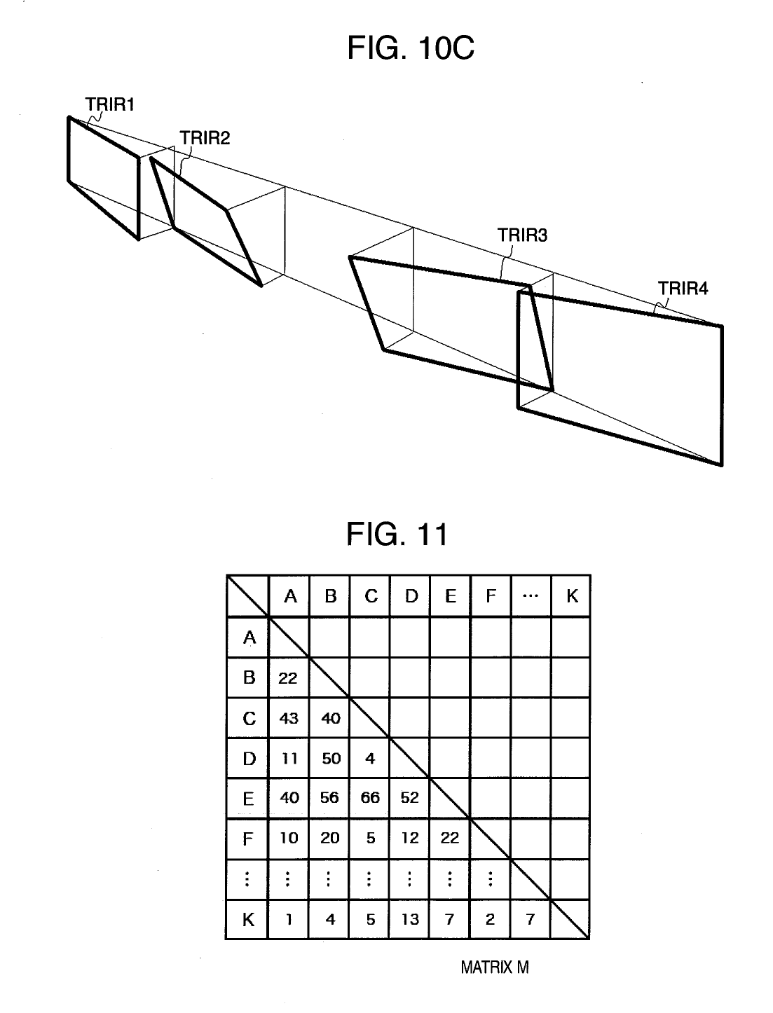

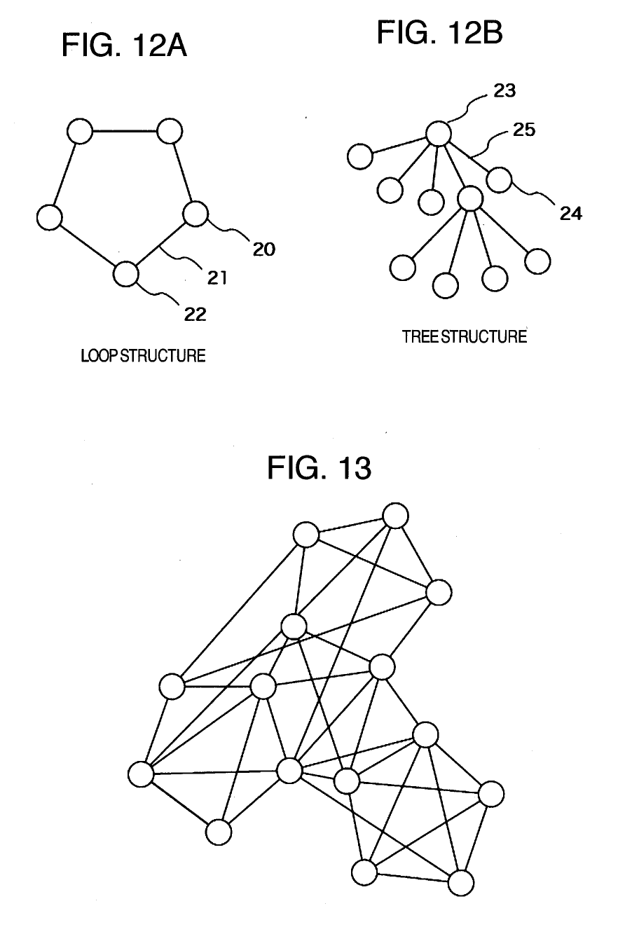

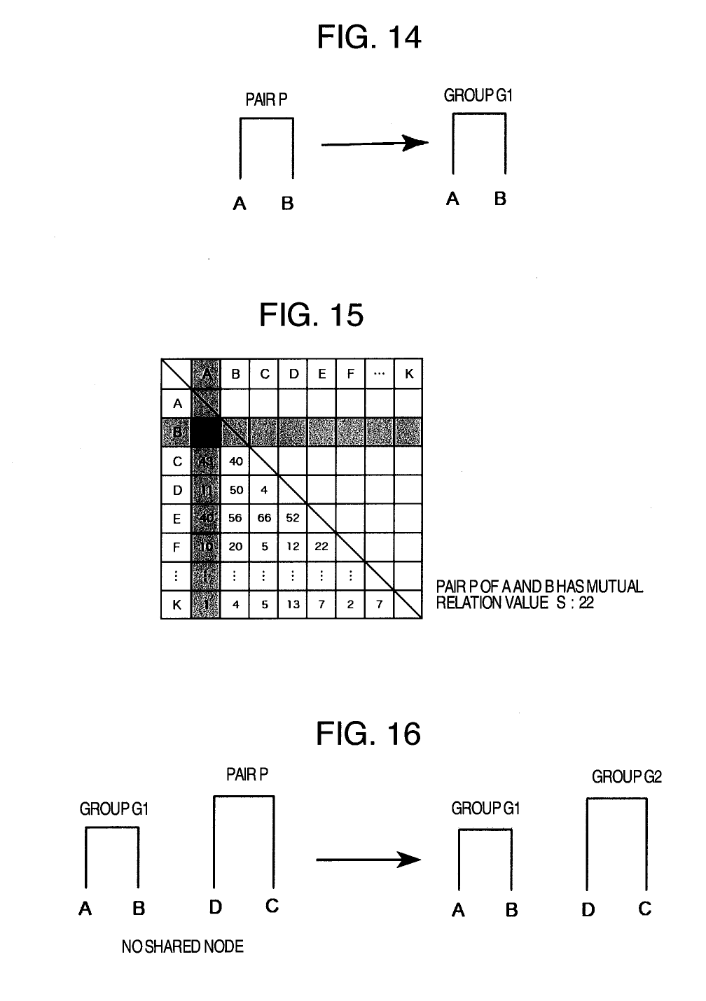

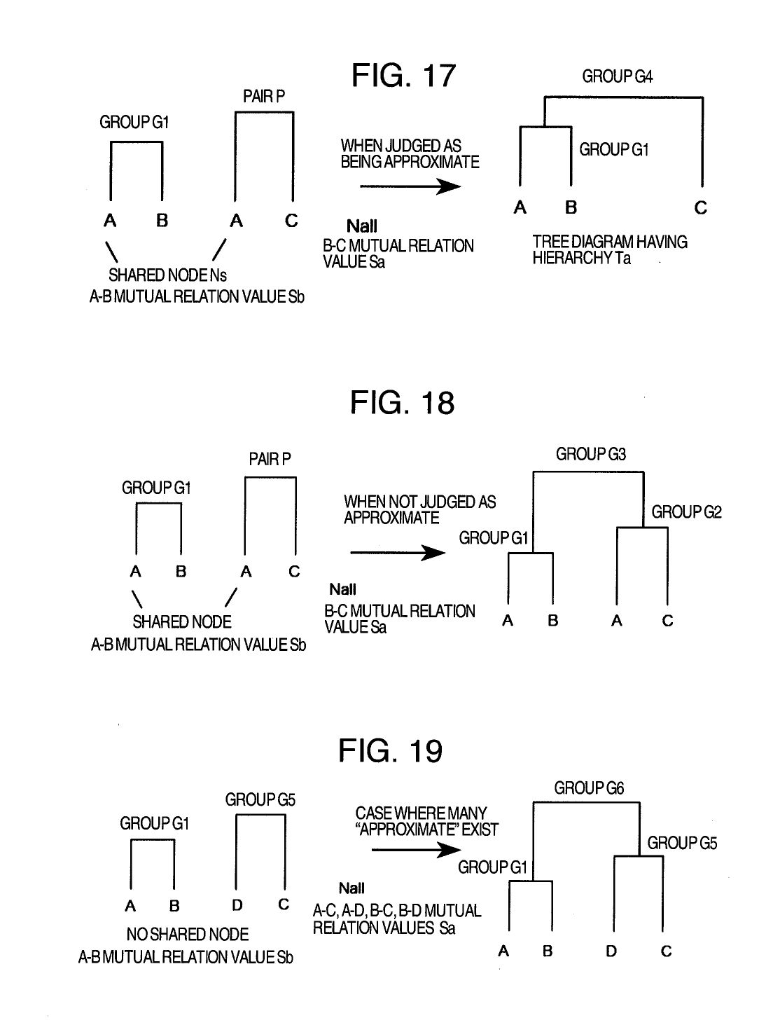

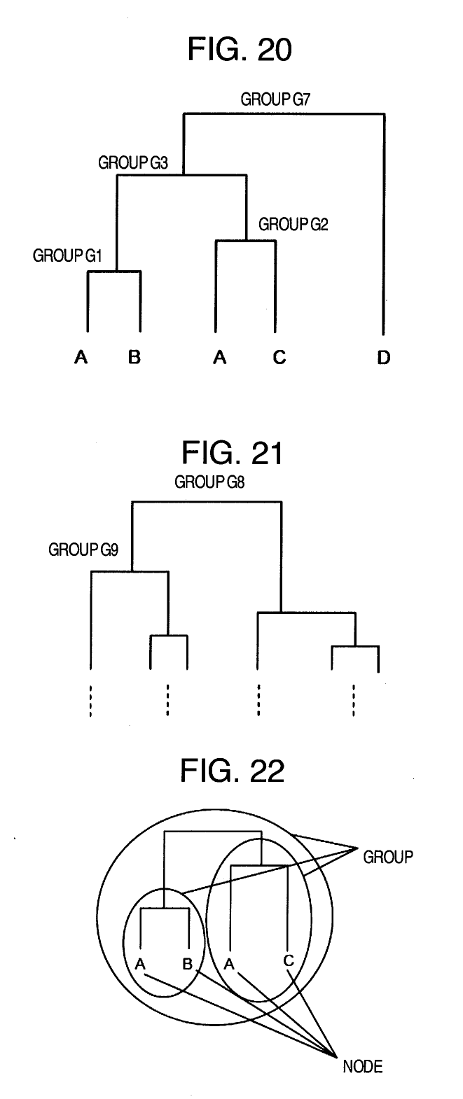

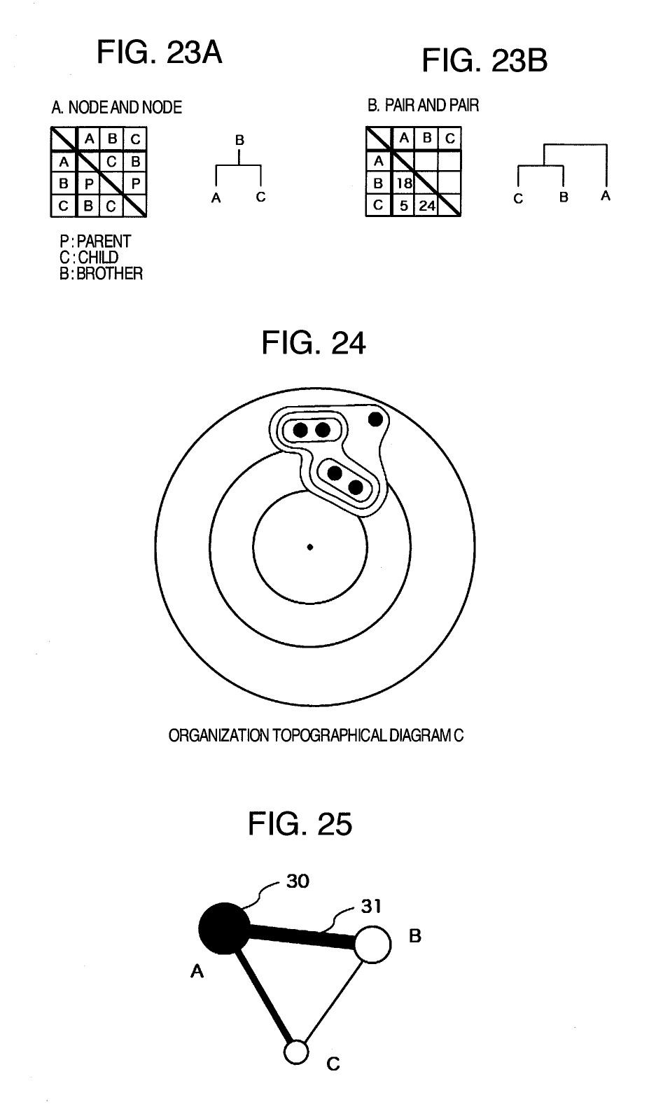

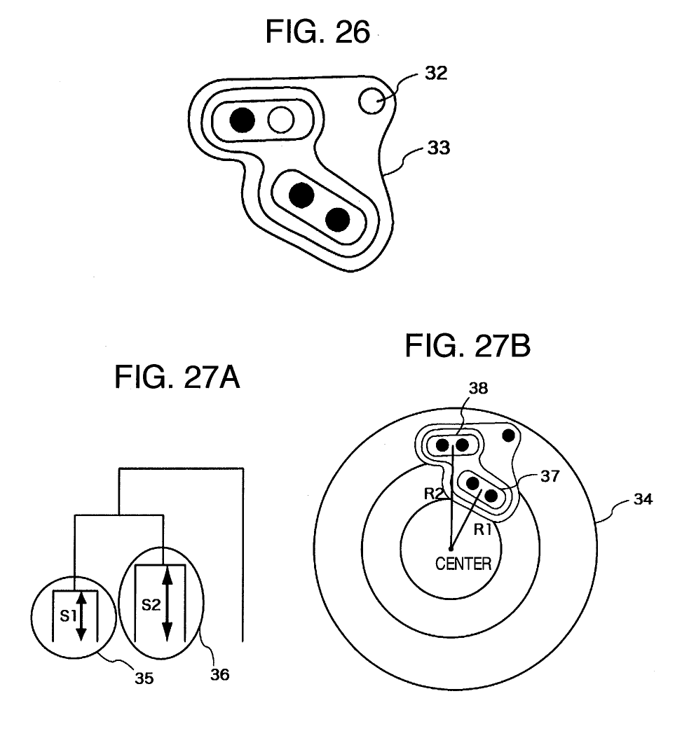

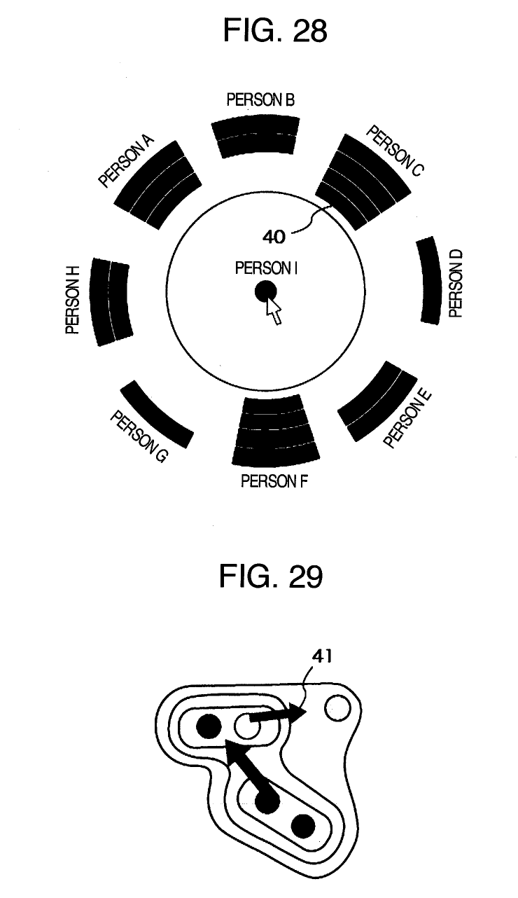

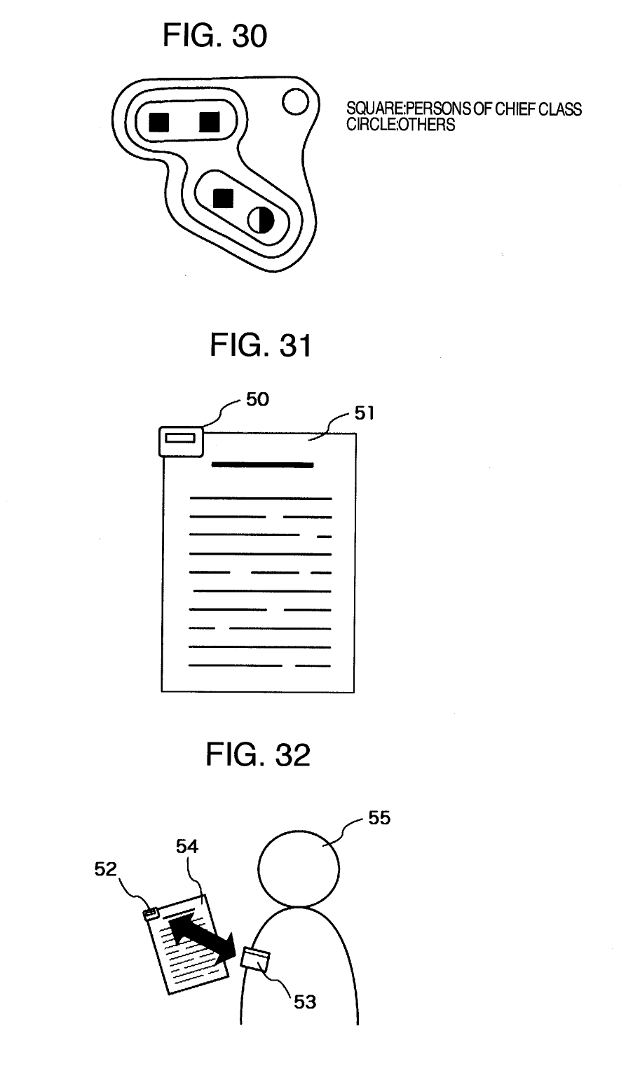

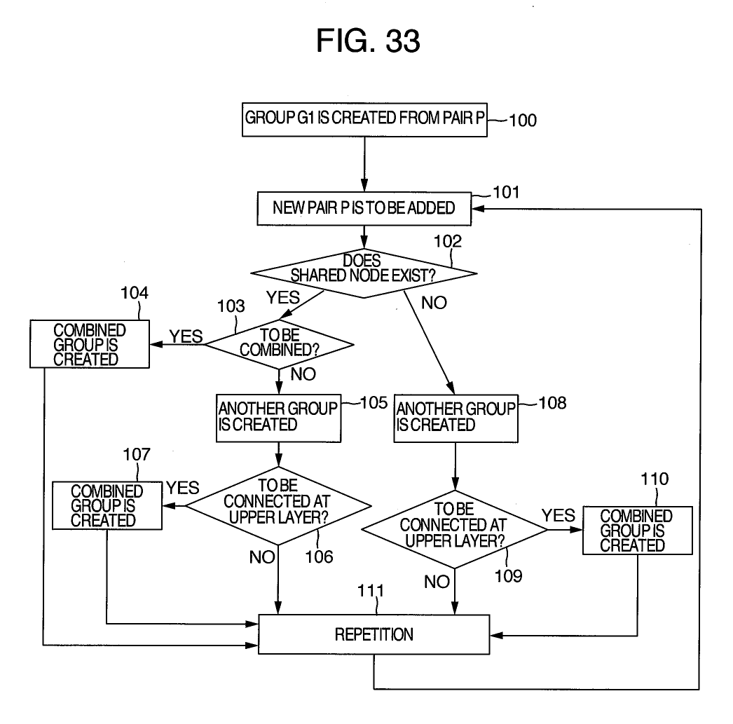

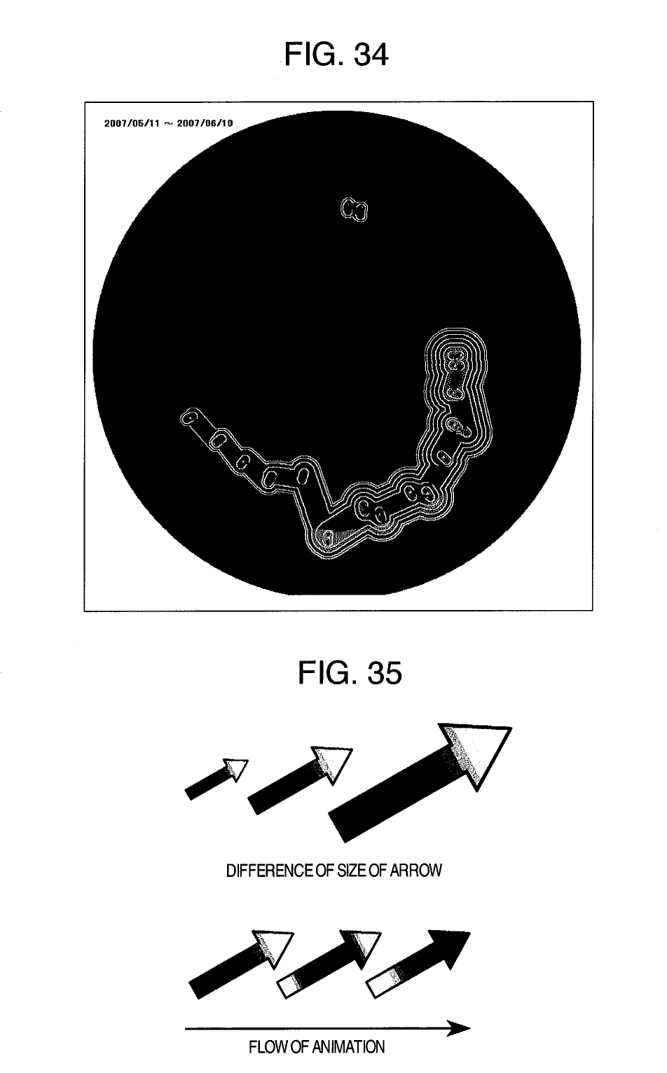

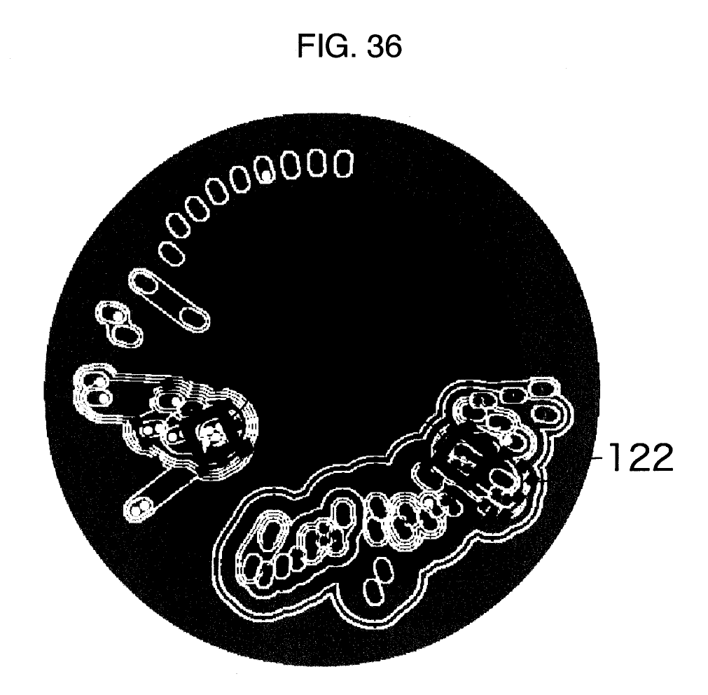

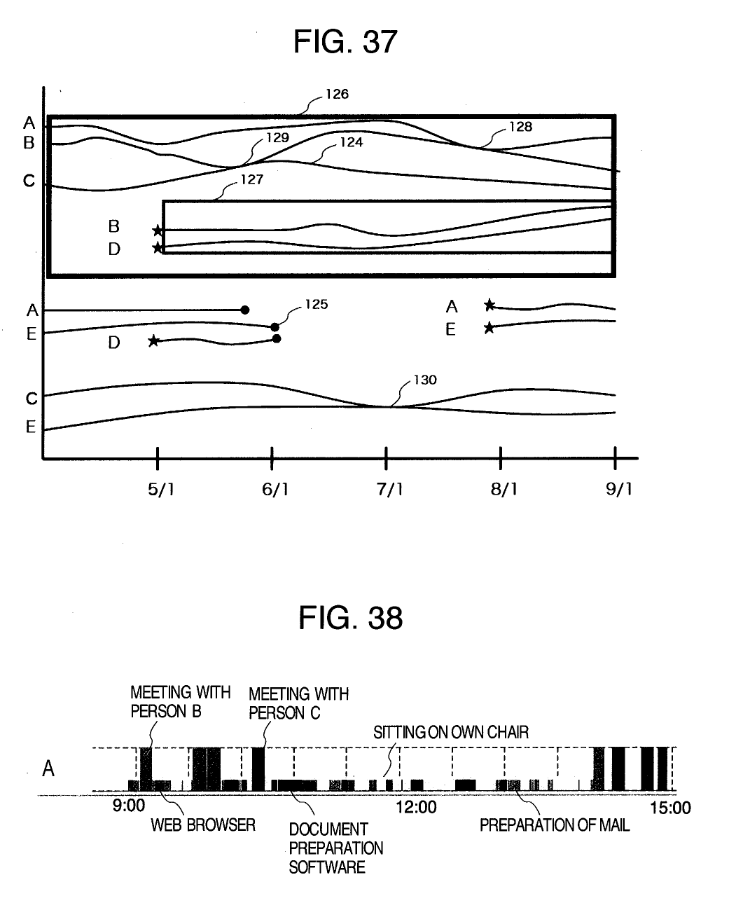

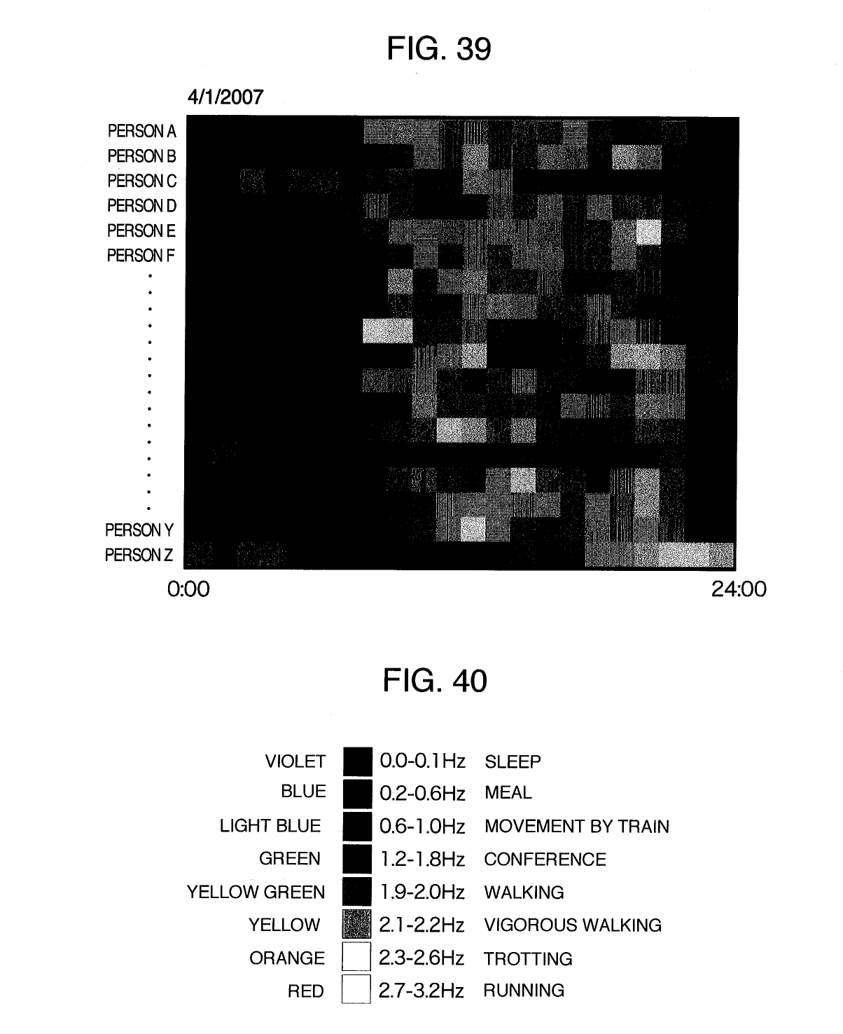

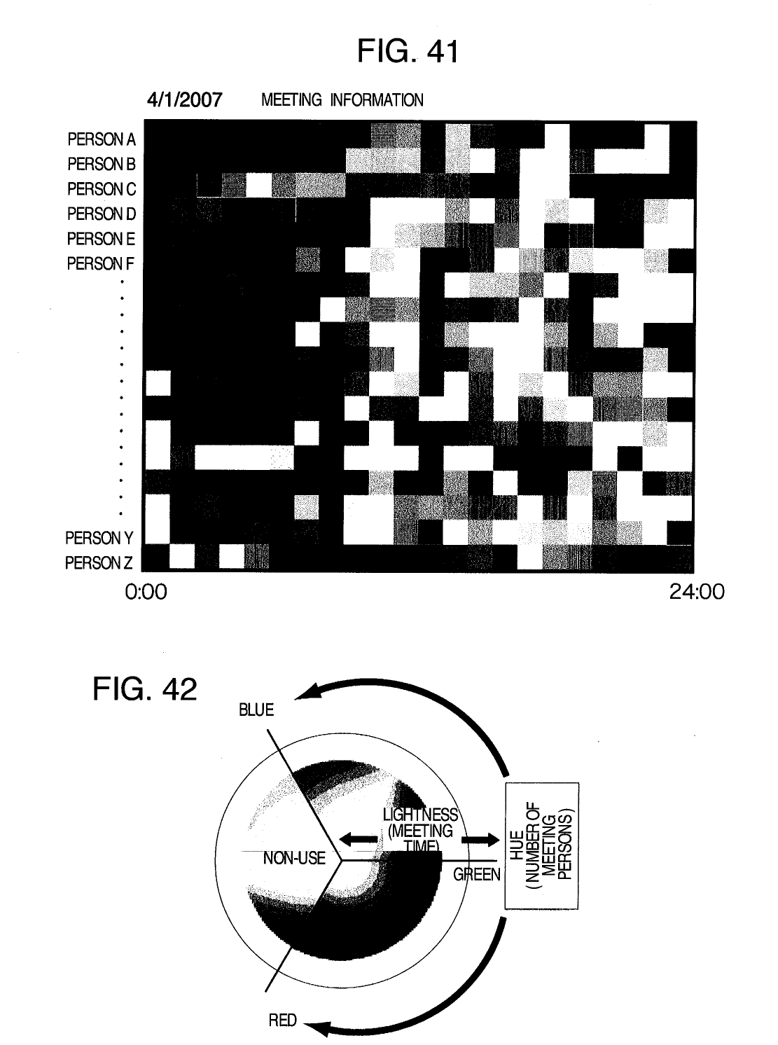

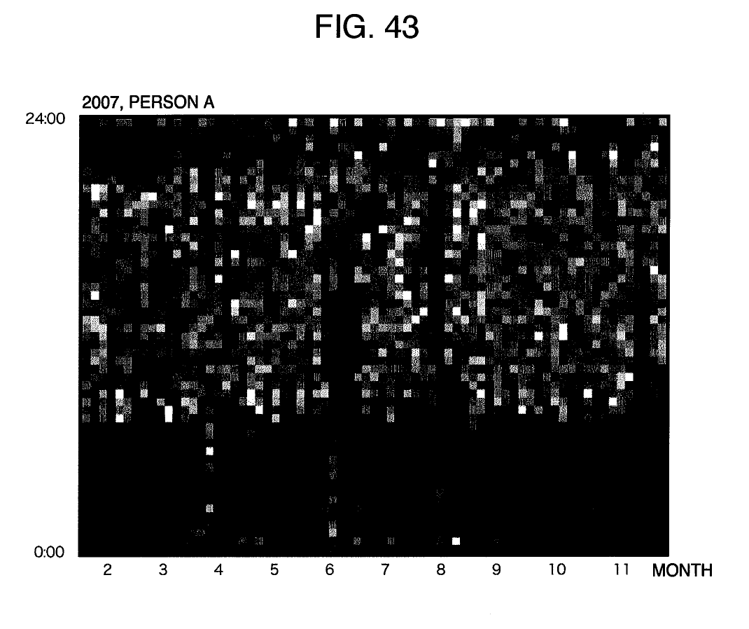

FIG. 11 shows an example of matrix generated from mutual relation values;

FIG. 12A shows a loop structure;

FIG. 12B shows a tree structure;

FIG. 13 shows an example of a network structure that becomes difficult to view owing to the loop structure;

FIG. 14 shows an example where a group is generated from a pair;

FIG. 15 shows a correspondence relation of mutual relation values read out from the pair and the matrix;

FIG. 16 shows an example where independent groups are generated when no shared node exists;

FIG. 17 shows an example where independent groups having hierachical layers are generated from pairs when a shared node exists;

FIG. 18 shows an example where groups are generated as groups to be combined after pairs are allowed to become independent when a shared node exists;

FIG. 19 shows an example where groups that become independent with no shared node are combined at upper layers into groups;

FIG. 20 shows an example of a tree diagram as a final output;

FIG. 21 shows a tree diagram that becomes a nesting structure;

FIG. 22 shows an example of nodes and groups;

FIG. 23A shows an example of a tree structure of the prior art and a group tree structure generated from a matrix having a quantity, and also showing a node and a node;

FIG. 23B shows an example of a tree structure of the prior art and a group tree structure generated from a matrix having a quantity, and also showing a pair and another pair;

FIG. 24 shows an example of organization topographical diagram;

FIG. 25 shows an example of an existing network structure;

FIG. 26 shows an example of visualization when a specific attention is paid to the groups;

FIG. 27A shows an example of the correspondence between the height of a tree and the depth of a relation inside a group;

FIG. 27B shows an example of the correspondence between a distance from the center of a concentric circle and the intensity inside the group;

FIG. 28 shows an example of perusing information with a node as the center;

FIG. 29 shows an example of display by overlaying additional information;

FIG. 30 shows an example of display of the additional information by various forms of expression;

FIG. 31 shows an example of a clip sensor;

FIG. 32 shows an operation of the clip sensor;

FIG. 33 is a flowchart showing an overall flow of generation of a tree structure;

FIG. 34 shows a display example of a value flow;

FIG. 35 shows a display example of arrows;

FIG. 36 shows an example of lines that encompass a portion that draws a specific attention;

FIG. 37 shows a display example of a chronological table of an organization;

FIG. 38 shows an example where utilization information of PC, etc, and sensor information are simultaneously displayed;

FIG. 39 shows a display example of a life tapestry owing to acceleration;

FIG. 40 shows an example where a frequency analytical result of acceleration and an action pattern are allowed to correspond to each other by coloration;

FIG. 41 shows a display example of a life tapestry owing to meeting information;

FIG. 42 shows an example where the number of meeting persons and a meeting time are associated with hue and lightness, respectively; and

FIG. 43 shows an example of life tapestry displaying in a period of several months unit.

### DESCRIPTION OF THE EMBODIMENTS

Preferred embodiments of the invention will be hereinafter explained with reference to the accompanying drawings.

### 1. Embodiment 1

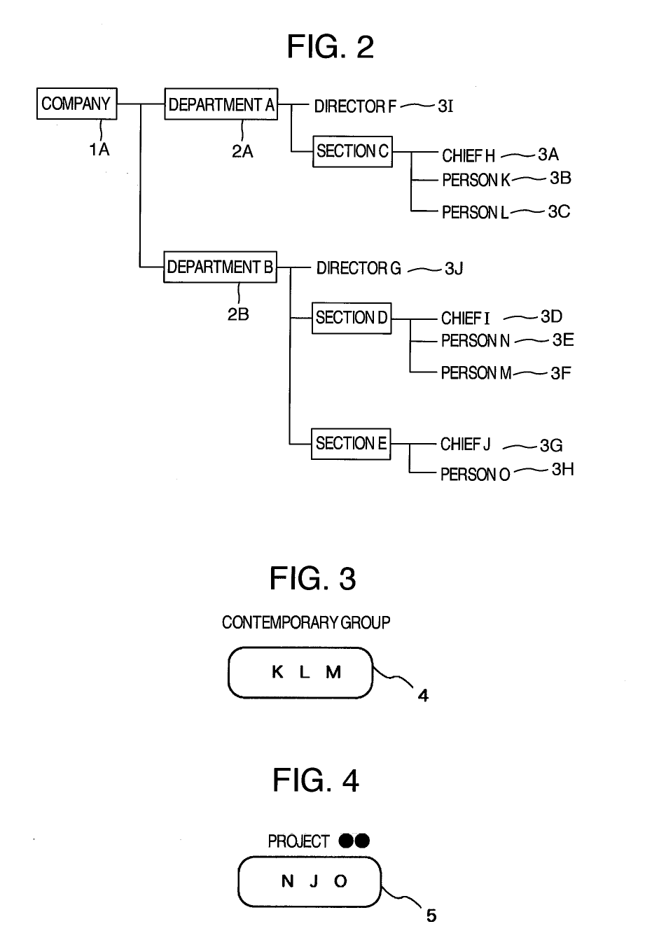

An organization such as a company is defined and managed by predetermined systems such as one's post as represented by an organization diagram and a project diagram. As illustrated in FIG. 2, for example, sub-groups 2A and 2B such as departments and sections exist below a large organization of “company” 1 and staffs 3A to 3J exist as constituent members of the organization. The roles, groups, etc, of the staffs are defined in this way.

When persons act in practice in the organization such as a company, their roles and attributes are diversified. Each person has a predetermined role and hence belongs to a plurality of groups. However, actions and activities of persons are not always restrained by a predetermined organization diagram and in some cases, the persons act differently from the actions they are supposed to do or neglect the activities of the section or department to which they originally belong.

It will be assumed, for example, that a person K (belonging to Department A, section C; subordinate of F and H, colleague with L) in FIG. 2 entered the company in the same year as L and M and often chats with them. Then, a group 4 shown in FIG. 3 is formed in practice. It will be assumed similarly that a person N (belonging to Department B, section D; subordinate of G and I, colleague with M) takes part in projects of the section E (often chats with J and O). Then, a group 5 shown in FIG. 4 is formed.

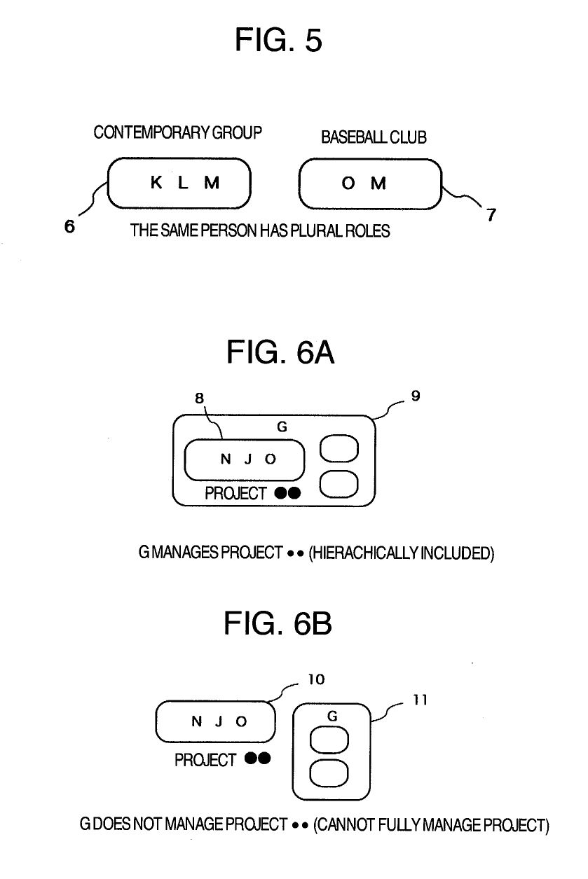

It will be assumed further that a person M (belonging to department B, section D; subordinate of G and I, colleague with N) is a good friend with O in a circle activity (baseball) besides the contemporaries with K and L. Then, M belongs not only to the contemporary group 6 shown in FIG. 3 but also to a group “baseball circle” 7 and “bears a plurality of roles”. Therefore, when depicted, Mappears at a plurality of sites as represented by 6 and 7 in FIG. 5.

Assuming, on the contrary, that a person G (director of department B, having sections D and E) is not much concerned (hardly sees or talks with or manage J, O and (N)) in a project of the section E that the director G should originally manage, the phenomenon that the group 10 and the group 11 do not practically have the relation of inclusion with each other and destruction of the system diagram shown in FIG. 6B may occur although the group 8 should be included in the group 9 in FIG. 6A provided that the director G sufficiently manages the project.

Whereas persons have new sections/departments and new jobs/roles depending on actions and activities not relying on the predetermined system diagram as shown in FIGS. 4 and 5, they do not fully carry out from time to time the tasks originally assigned to them in the system diagram. In this way, “true groups” are formed by such actual actions and activities of the persons. However, such groups are not depicted clearly by the system diagram or the project diagram and have been extremely difficult to grasp as a whole.

Therefore, the present invention makes it possible to visualize the “true group” that has not been grasped in the past as shown in FIGS. 3 to 6 by merely attaching nameplate sensor nodes for acquiring the actions of persons and relations among persons and sensing their actual actions and relations but not the attributes of the persons in the designated positions. In one concrete example, a “true group” different from a designated group is generated with a hierachical structure from meeting information by a sensor network and is expressed so that the organization can be grasped as a whole and management can be made effectively.

More concretely, a group visualization system according to the invention includes a sensor network containing a plurality of sensor nodes that correspond on the 1:1 basis to a plurality of persons constituting an organization and an analyzing unit for analyzing the relation among the plurality of persons from a physical value relating to each of these persons detected by the sensor network, wherein an unknown group or groups in the organization are extracted from the relation of the plurality of persons and are visualized.

### <Outline of Sensor Network (Business Microscope) System>

To clarify positioning and functions of the nameplate type sensor nodes in the invention, a business microscope system will be first explained. The term “business microscope” means a system that observes the status of a person wearing the sensor node, illustrates the relation among persons and the present evaluation (performance) of the organization as business activities and is used to improve the organization.

Data about meeting detection, behavior, sound, and so forth, detected by the sensor nodes are called generically and broadly “organization dynamics data”.

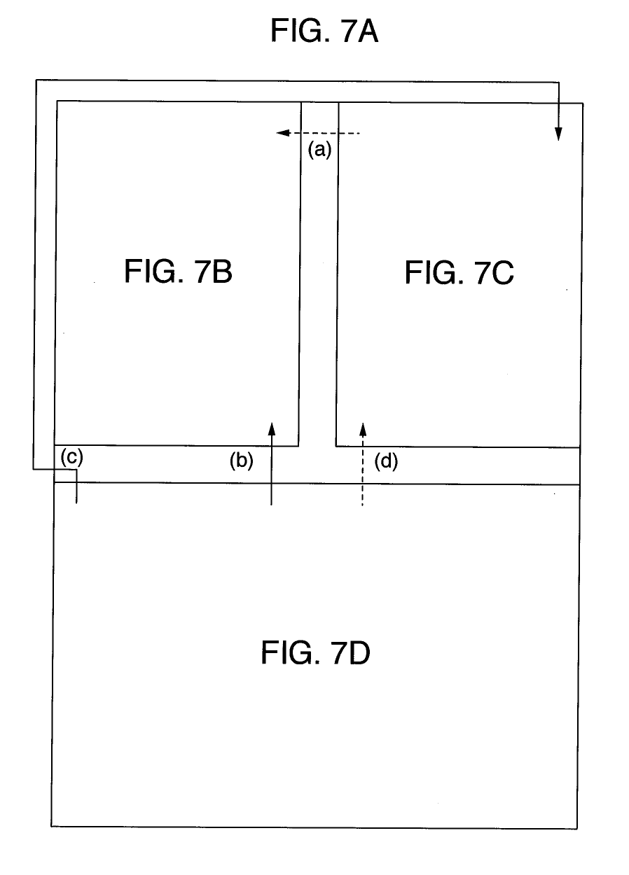

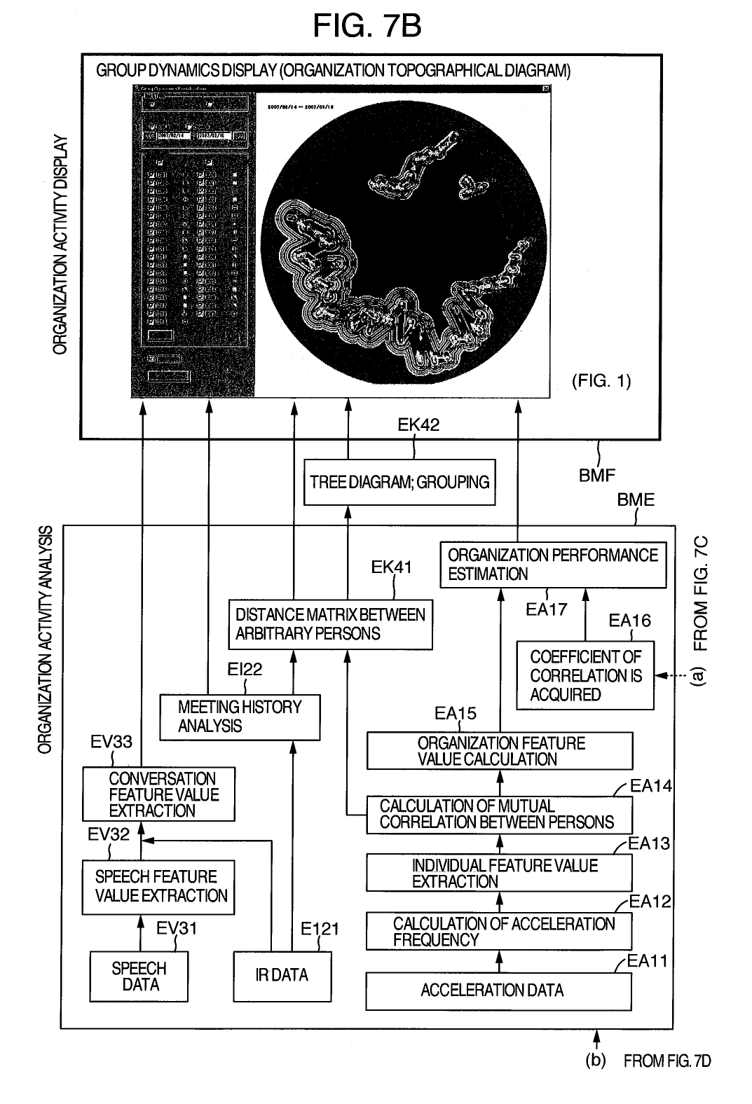

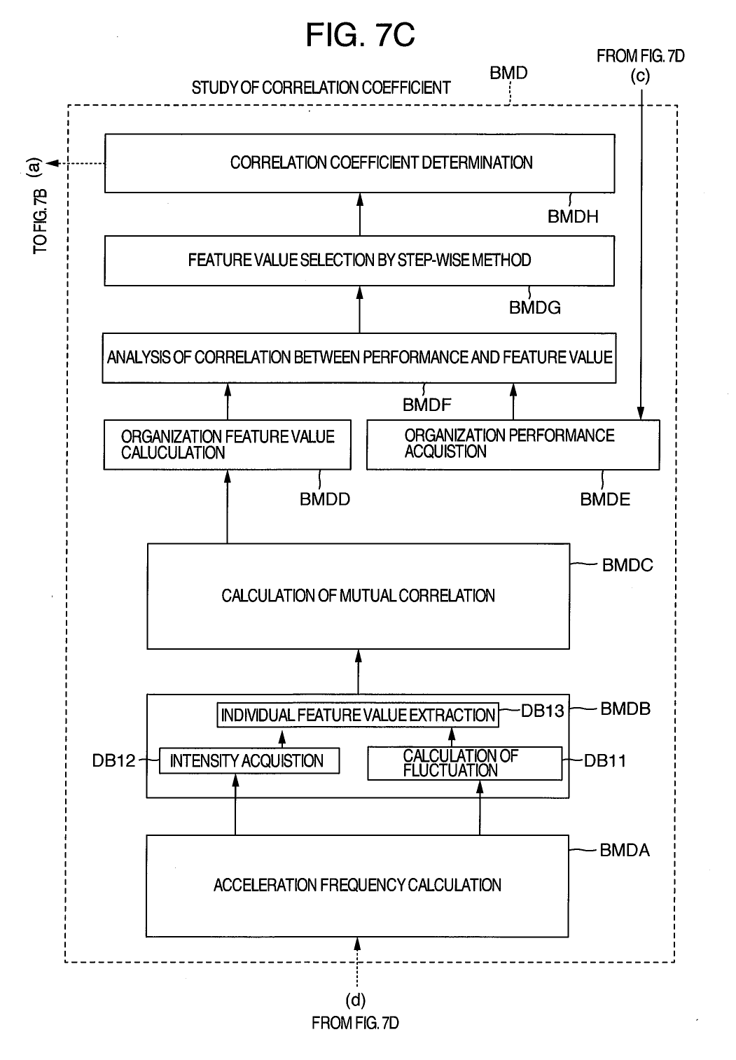

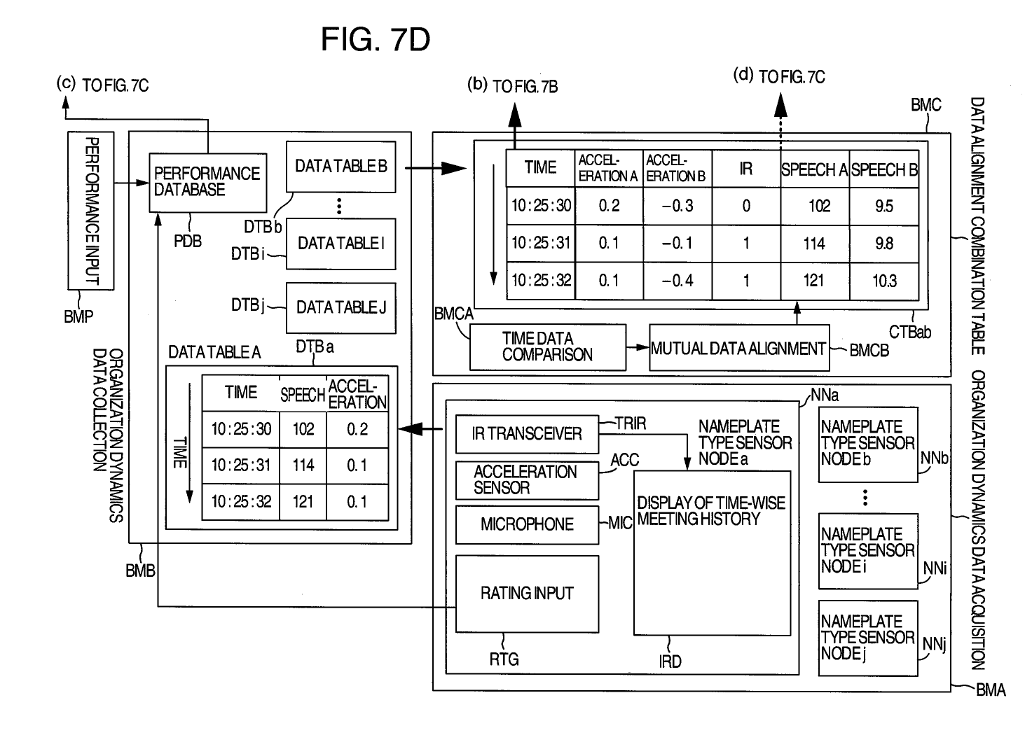

FIGS. 7A to 7D are explanatory views representing the overall flow of the processing executed in the business microscope system. The drawings illustrate a series of flows from the acquisition of the organization dynamics data by a plurality of nameplate type sensor nodes to the relationship among the persons as the organization activities and the present organization evaluation (performance).

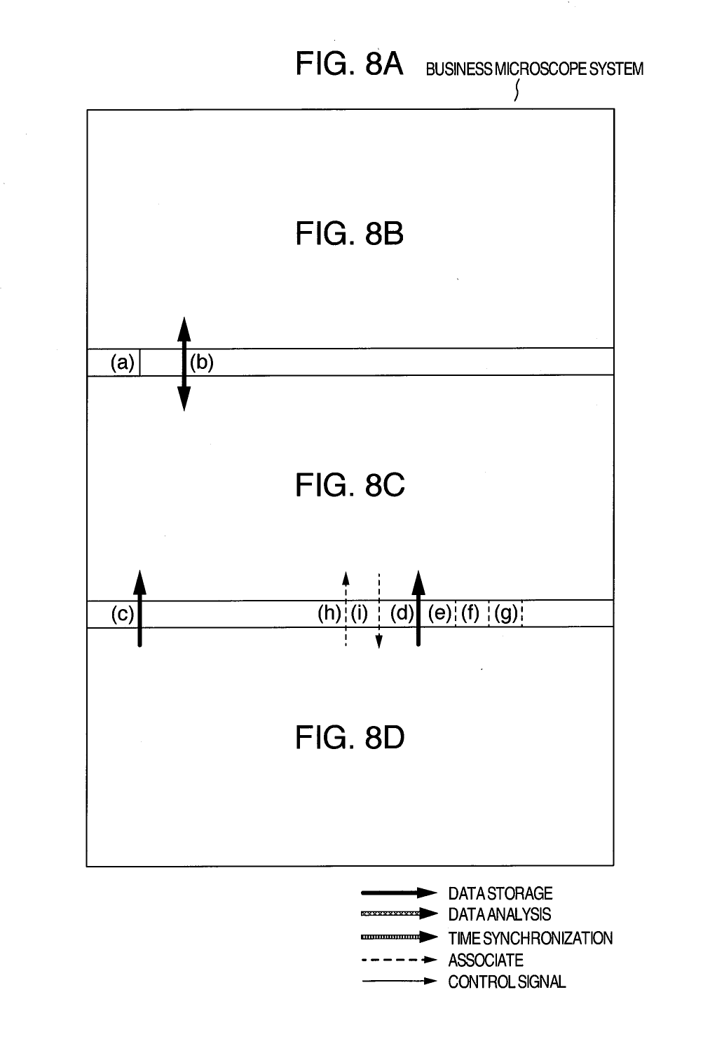

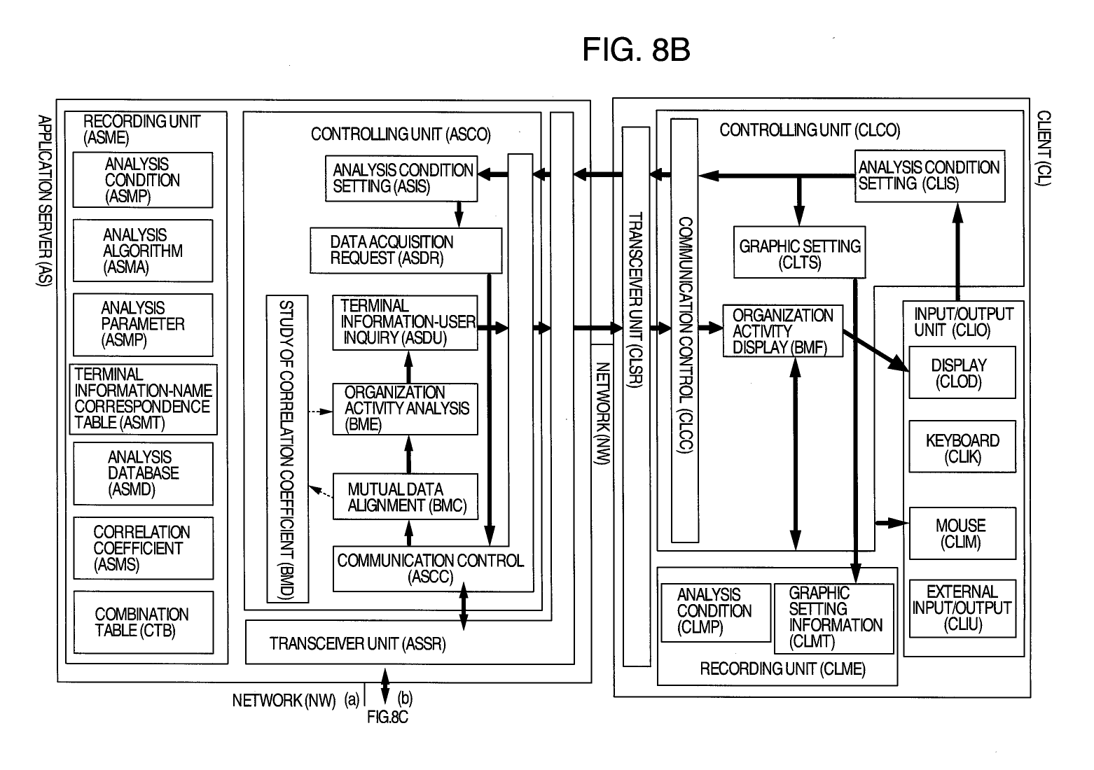

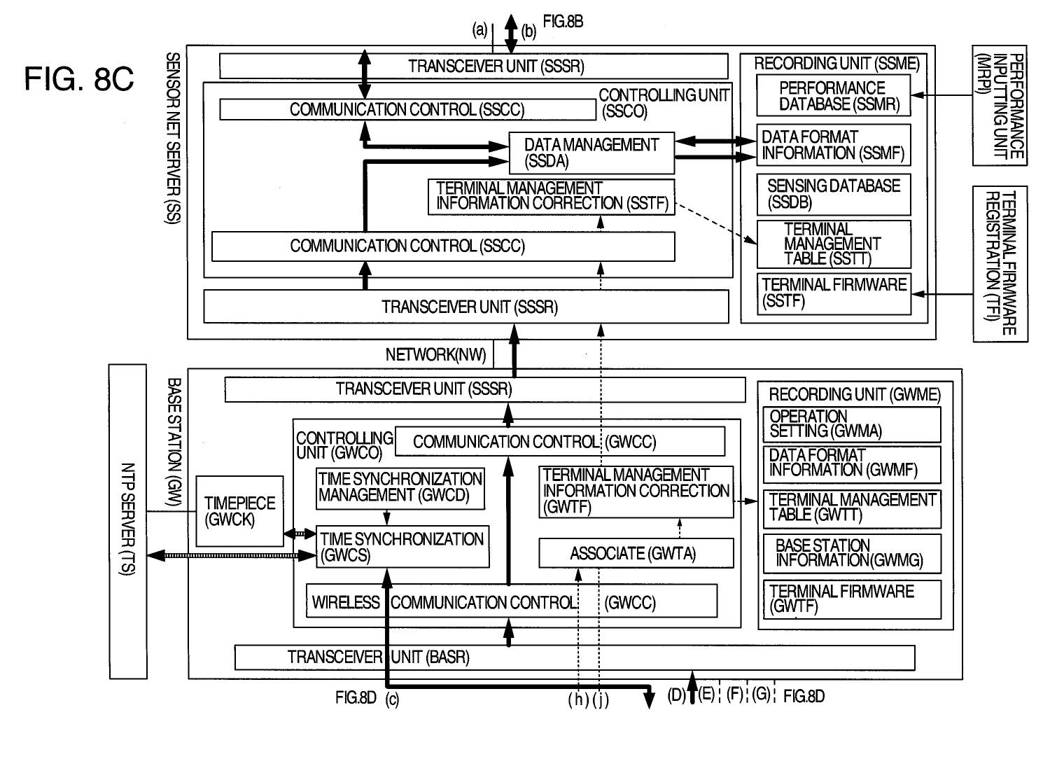

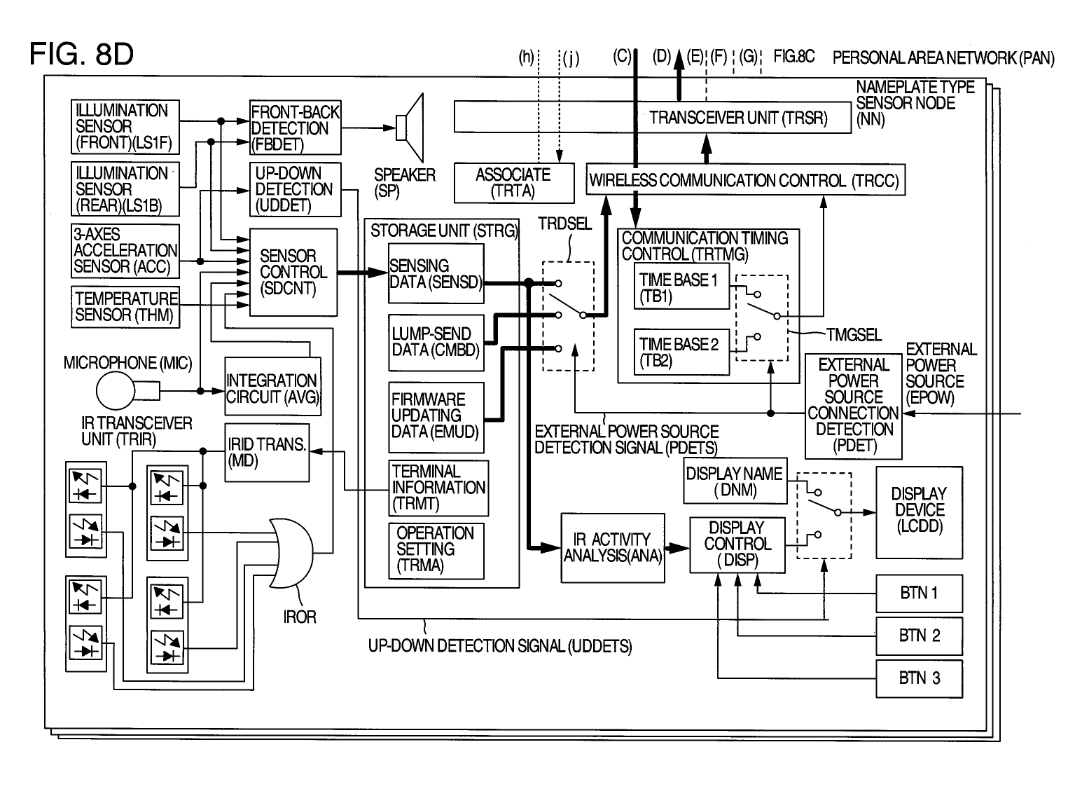

This embodiment relates to a group visualization system including a processing unit for acquiring organization dynamics data (BMA), a processing unit for inputting performance (BMP), a processing unit for collecting the organization dynamics data (BMB), a processing unit for aligning mutual data (BMC), a processing unit for studying mutual functions (BMD), a processing unit for analyzing organization activities (BME) and a processing unit for displaying organization activities (BMF), or a sensor network system that accomplishes the group visualization system on a sensor network. Each processing unit executes each processing in an appropriate order. Apparatuses for executing these kinds of processing and an overall construction of a system including these apparatuses will be explained later with reference to FIGS. 8A to 8D.

To begin with, the organization dynamics data acquisition (BMA) shown in FIG. 7D will be explained. The organization dynamics data acquisition unit includes a plurality of sensor nodes to which sensors are mounted and which correspond on the 1:1 basis to a plurality of persons constituting the organization. The physical value detected by each sensor node is acquired as data of each of the persons and the data so acquired is wireless transmitted. The nameplate type sensor node A (NNa) has an acceleration sensor (ACC), an infrared transceiver (TRIR), sensors such as a microphone (MIC), a screen IRD for displaying meeting information obtained from the infrared transceiver, an interface RTG for inputting rating of action, and a microcomputer and a wireless transmission function that are not shown in the drawing. IRD is made by displaying time, name of person who was meeting, and meeting count. RTG is made by a cursor and a score which can be selected. User can be moving the cursor and rating by selecting the score.

The acceleration sensor (ACC) detects acceleration of the nameplate type sensor node A (that is, acceleration of a person A (not shown) wearing the nameplate type sensor node A (NNa)). The infrared transmitter/receiver (TRIR) detects the meeting state of the nameplate type sensor node A (NNa) (that is, the state under which the nameplate type sensor node A (NNa) meets other nameplate type sensor node). Incidentally, the state under which the nameplate type sensor node A (NNa) meets other nameplate type sensor node represents the state under which the person A wearing the nameplate type sensor node A (NNa) meets other person wearing the nameplate type sensor node. The microphone (MIC) detects the sound around the nameplate type sensor node A (NNa).

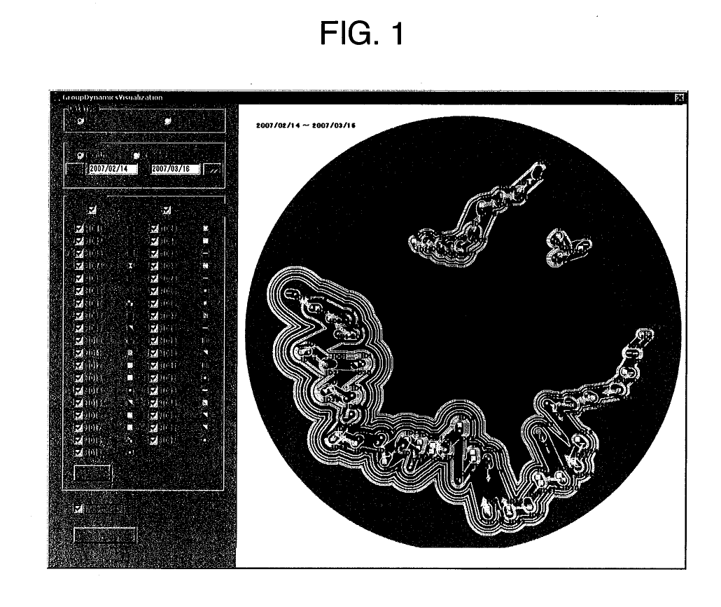

The system in this embodiment includes a plurality of nameplate type sensor nodes (nameplate type sensor nodes A (NNa) to nameplate type sensor node N (NNj) shown in FIG. 1). Each nameplate type sensor node is worn by each person. For example, the nameplate type sensor node A (NNa) is fitted to the person A and the nameplate type sensor node B (NNb), to the person B (not shown). This is for analyzing the relationship between the persons and for illustrating the performance of the organization.

Incidentally, the nameplate type sensor node N (NNb) to the nameplate type sensor node J (NNj) have the sensors, the microcomputers and the wireless transmission function in the same way as the nameplate type sensor node A (NNa). In the following explanation, the term “nameplate type sensor node (NN)” will be used when the explanation can be applied as such to all of the nameplate type sensor nodes A (NNa) to J (NNj) and when these nameplate type sensor nodes need not be distinguished in particular from one another.

Each nameplate type sensor node (NN) always (or repeatedly in a short cycle) executes sensing by the sensors. Each nameplate type sensor node (NN) wireless transmits the data acquired (sensing data) in a predetermined cycle. The data transmission cycle may well be the same as or greater than the sensing cycle. At this time, the sensing time and an ID unique to the nameplate type sensor node (NN) that executes sensing are allotted to the data transmitted. Wireless transmission of the data is collectively executed in order to restrain power consumption by transmission and to keep the usable condition of the nameplate type sensor node (NN) for a long period while the person wears the sensor node. The same sensing node is preferably set to all the nameplate type sensor nodes (NN) for the subsequent analysis.

The performance input (BMP) shown in FIG. 7D is a processing for inputting values representing the performance. Evaluation of the organization by each of a plurality of persons is inputted from the performance inputting unit on the basis of a predetermined reference. Here, the term “performance” means a subjective or objective evaluation made on the basis of a certain reference. For example, a person wearing the nameplate type sensor node (NN) inputs at predetermined timing the values of the subjective evaluation (performance) on the basis of a certain reference such as a degree of achievement of duty, a degree of contribution and satisfaction to the organization, and so forth. The inputting operation may be made once several hours, once a day or at the point of time at which an event such as a conference is finished. The person wearing the nameplate type sensor node (NN) can input the performance value by operating the nameplate type sensor node (NN) or a PC (Personal Computer) such as a client (CL). Alternatively, handwritten values may be altogether inputted later by the PC. In this embodiment, the nameplate type sensor node represents an example where performances such as Health Condition, Mental Condition and learning desire (Study) can be inputted. The performance values so inputted are used to learn coefficients of correlation. Values need not be further inputted once performance values sufficient enough for learning are acquired to a certain extent.

The performance about the organization may be calculated from the performances of individuals. Data that have already been expressed by numeration such as objective data, e.g. sales amount or cost, and the result of questionnairing of customers may be inputted periodically as the performances. When a numerical value can be automatically acquired such as an error occurrence ratio in production management, the resulting numerical value may be inputted automatically as the performance value.

The data wireless transmitted from each nameplate type sensor node (NN) are collected in the system dynamics data collection (BMB) shown in FIG. 7D and are stored in a database. The system dynamics data collecting unit collects the data and performance outputted from the system dynamics data acquiring unit and the performance inputting unit, respectively, and stores them as a data table and a performance table. For example, the data table is generated for each nameplate type sensor node (NN) or in other words, for each person wearing the nameplate type sensor node (NN). The data so collected are classified on the basis of the inherent ID and are stored in the order of the sensing time. When the table is not generated for each nameplate type sensor node (NN), a column for representing the ID information of the nameplate type sensor node or the person becomes necessary inside the data table. Incidentally, the data table A (DTBa) shown in the drawing represents the data table in a simplified form.

The value of the performance inputted in performance input (BMP) is stored in the performance database (PDB) with the time information.

To compare the data of two arbitrary persons (in other words, data acquired by the nameplate type sensor nodes (NN) these persons wear), the data about the two persons are aligned (alliance) in the mutual data alignment (MBC) shown in FIG. 7D on the basis of the time information. The mutual data aligning unit inputs the data of the arbitrary two persons among a plurality of persons from the system dynamics data collecting unit and aligns two sets of data inputted on the basis of the time information. The data thus inputted are stored in the table. At this time, the data of the same time among the data of the two persons are stored in the same record (row). The term “data of the same time” means two kinds of data containing the physical values detected at the same time by the two nameplate sensor nodes (NN). When the data about the two persons do not contain the data of the same time, the data having the most approximate time relative to each other may be used approximately as the data of the same time. In this case, the data having the most approximate time are stored in the same record. It is preferred in this case that the time of the data stored in the same record be put in order by using the mean value of the most approximate time, for example. These kinds of data may well be stored in such a fashion that data comparison can be made by a time series, and need not always be stored in the table.

The combination table (CTBab) shown in FIG. 7D shows in a simplified form an example of a table as a combination of a data table A (DTBa) and a data table B (DTBb). However, the detail of the data table (DTBb) is omitted from illustration. The combination table (CTBab) contains data of acceleration, infrared rays and sound. A combination table in accordance with the kind of data such as a combination table containing only acceleration table or a combination table containing only sound may be generated, too.

To calculate the relationship and estimate the performance from the organization dynamics data, this embodiment executes study (BMD) of the coefficient of correlation shown in FIG. 7C. For this purpose, the coefficient of correlation is first calculated by using past data for a predetermined period. This process becomes more effective when data is re-calculated periodically by using new data to update the coefficient of correlation. The correlation coefficient studying unit calculates a feature value of each of the two persons on the basis of two sets of data inputted from the mutual data aligning unit, calculates the organization feature value as a feature value of the organization on the basis of the correlation of the two calculated from the pair of feature values, acquires the organization performance as the performance of the organization on the basis of the output of the performance database, analyzes the correlation of the organization feature value and the organization performance and decides the coefficient of correlation. The following explanation represents the case where the coefficient of correlation is calculated from the acceleration data but it can be calculated similarly by using the time series data such as the sound data in place of the acceleration data.

In this embodiment, studying (BMD) of the coefficient of correlation is executed by an application server (AS) (see FIG. 8B). However, practical studying of the coefficient of correlation (BMD) may be executed by apparatuses other than the application server (AS).

To begin with, the application server (AS) sets the width T of the data used for calculating the coefficient of correlation to several days to several weeks and selects the data during such a period.

Next, the application server (AS) carries out the acceleration frequency calculation (BMDA) shown in FIG. 7C. This acceleration frequency calculation (BMDA) is a processing for determining the frequency from the acceleration data that are aligned in a time series. The frequency is defined as the number of vibrations of a wave within one second and is an index representing the intensity of vibrations. Fourier transform must be conducted to calculate a correct frequency and a calculation load is great. The frequency may be calculated steadily by using Fourier transform but this embodiment employs a zero cross value as a value corresponding to the frequency to simplify the calculation.

The term “zero cross value” represents the number of times in which the value of the time series data reaches zero within a predetermined period. Speaking more correctly, the term represents the number of times of the change of the time series data from a positive value to negative and vice versa. Assuming, for example, that the period in which the value of acceleration changes from positive to negative and again changes from positive to negative next time is regarded as one cycle, the number of vibrations per second can be calculated from the number of times of zero cross calculated. The number of vibrations per second calculated in this way can be used as an approximate frequency of acceleration.

Since the nameplate type sensor node (NN) of this embodiment has an acceleration sensor in 3-axes directions, one zero cross value can be calculated by summing the zero cross values in the 3-axes directions within the same period. Therefore, the pendulum motion in the transverse direction and the longitudinal direction can be detected, in particular, and can be used as an index representing the intensity of vibration.

As a “predetermined period” for counting the zero cross value, a value greater than a continuous data interval (that is, original sensing period) is set in a second or minute unit.

The application server (AS) further sets a window width was a time width that is greater than the cross value but smaller than the total data width T. In the next step, the frequency distribution and fluctuation for each window is calculated by serially moving the window in the time axis.

When the window is moved by the width that is the same as the window width w at this time, overlap of data contained in each window can be eliminated. As a result, a feature value graph used for subsequent calculation of the mutual relation (BMDC) becomes a discrete graph. When the window is moved by the width smaller than the window width w, a part of data in each window overlaps. As a result, a feature value graph used for subsequent calculation of the mutual relation (BMDC) becomes a continuous graph. The moving width of the window may be set arbitrarily by taking these factors into account.

Incidentally, the zero cross value is expressed also as “frequency” in FIG. 7C. In the explanation that follows, the term “frequency” is a concept including the zero cross value. A correct frequency calculated by Fourier transform may be used as the following “frequency” or an approximate frequency calculated from the zero cross value may be used, too.

Next, individual feature value extraction (BMDB) is carried out by the application server (AS) in FIG. 7C. The individual feature value extraction (BMDB) is a processing for extracting the feature value of an individual by calculating the frequency distribution of acceleration and frequency fluctuation inside each window.

First, frequency distribution (that is, intensity) is calculated by the application server (AS) (DB12).

In the embodiment of the invention, the term “frequency” means frequency of the occurrence of acceleration of each frequency.

The frequency distribution of acceleration reflects what time the person wearing the nameplate type node sensor spends for what action. For example, the occurring frequency of acceleration is different when the person is walking and when the same person is mailing an e-mail. The occurrence frequency of acceleration for each frequency is determined to record a histogram of the history of such acceleration.

In this instance, the application server (AS) decides the maximum frequency that is assumed (or is required). The application server (AS) then divides the frequency so decided into 32 units from 0 to the maximum value. The application server (AS) counts the number of acceleration data contained in each frequency range so divided. The occurrence frequency of acceleration for each frequency calculated in this manner is handled as the feature value. The same processing is executed for each window.

The application server (AS) calculates “fluctuation for each frequency” in addition to the frequency distribution of acceleration (DB11). The term “frequency fluctuation” is a value representing for what period the frequency of acceleration is continuously kept.

Fluctuation for each frequency is an index representing how long the behavior of a person lasts. For example, meaning of the behavior is different for a person who walks for 30 minutes within one hour between the case where the person walks for one minutes and stands still for one minute and the case where the person walks continuously for 30 minutes and takes rest for 30 minutes. These behaviors can be discriminated by calculating the fluctuation for each frequency.

Here, the range of the difference between two continuous values is important for judging whether or not the value is kept as such and the amount of fluctuation greatly varies depending on setting of the reference. Furthermore, the information representing the dynamics of the data as to whether the value changes slightly or remarkably falls off. In the embodiment of the invention, therefore, the full range of the frequency of acceleration is divided into the predetermined number of divisions. The term “full range of frequency” means the range from 0 to the maximum value. The divided zones are used as a reference for judging whether or not the value is maintained. When the number of divisions is 32, for example, the full range of the frequency is divided into 32 zones.

For example, when the frequency of acceleration at a certain time t exists within the ith zone and the frequency of acceleration at a next time t+1 exists inside any of the (i−1) the zone or the ith zone or the (i+1)th zone, the value of the frequency of acceleration is judged as being maintained. When the frequency of acceleration at a time t+1 does not exist inside any of the (i−1)th, ith and (i+1)th zones, on the other hand, the value of the frequency of acceleration is not judged as being maintained. The number of times of judgment of the value as being maintained is counted as a feature value representing the fluctuation. The process described above is executed for each window.

The feature values representing the fluctuation when the numbers of divisions are set to 16, 8 and 4 are calculated, respectively. When the number of divisions is changed in this way in the calculation of fluctuation for each frequency, both the small change and the great change can be reflected on any of the feature values.

Let's consider the case where the full range of the frequency is divided into 32 zones and transition from an arbitrary zone i to an arbitrary zone j is tracked. In this case, 1,024 transition patterns as the square of 32 must be taken into account, thereby inviting the problem that the calculation amount becomes greater with an increasing pattern number. Another problem besides this problem is that an error becomes statistically greater because the data applicable to one pattern becomes smaller.

In contrast, when the feature values are calculated by setting the numbers of divisions to 32, 16, 8 and 4 as described above, only 60 patterns must be taken into account and statistical reliability becomes higher. In this way, the embodiment provides the effect that diversified transition patterns can be reflected on the feature values by calculating the feature values for several numbers of divisions from a large number of divisions to a small number of divisions.

The above explains the calculation method of the frequency distribution of acceleration and its fluctuation. When the application server (AS) acquires data other than the acceleration data (such as sound data), the application server (AS) can execute a processing similar to the processing described above for that data. As a result, the feature volume can be calculated on the basis of the data acquired.

The application server (AS) handles the frequency distributions of the 32 patterns calculated as described above and the degrees of fluctuation for the frequencies of 60 patterns, or 92 values in total, as the feature value of the person A in the time zone of each window (DB13). Incidentally, these 92 feature values (xA1 to xA92) are completely independent.

The application server (AS) calculates the feature value described above on the basis of the data transmitted from the nameplate type sensor nodes (NN) of all the members belonging to the organization (or all the members as the object of analysis). Because the feature value is calculated for each window, the feature value of one member can be handled as time series data by plotting the feature values in the order of the time of the window. Incidentally, the time of the window can be determined in accordance with an arbitrary rule. For example, the window time may be the center time of the window or the starting time of the window.

The feature volume (xA1 to xA92) described above is the feature value about the person A calculated on the basis of the acceleration detected by the nameplate type sensor node (NN) fitted to the person A. Similarly, the feature value (xB1 to xB92, for example) about other person (person B, for example) can be calculated on the basis of the acceleration detected by the nameplate type sensor node (NN) fitted to that person.

Next, the application server (AS) calculates the mutual relation (BMDC) that is in FIG. 7C. The mutual relation calculation is a processing for determining the mutual relation of the feature values about two persons. These two persons will be assumed to be the person A and the person B.

The graph of the feature value xA in the mutual relation calculation in FIG. 1 represents the graph of the time series change of a certain feature value about the person A. Similarly, the graph of the feature value xB in the mutual relation calculation (BMDC) represents the graph of the feature value about the person B.

At this time, the influences that a certain feature value (xB1, for example) of the person B receives from the feature value (xA1, for example) of the person A can be expressed as the function of time z in the following way:

$$R ( τ ) = \frac{1}{{T}^{′}} {\int }_{0}^{{T}^{′}} \{ {x}_{A 1} ( t ) - \overline{{x}_{A 1}} \} \{ {x}_{B 1} ( t ) - \overline{{x}_{B 1}} \} d t ( \begin{matrix}{T}^{′} = T - τ \\ τ = - T ∼ T\end{matrix} ) \qquad ( Expression 1 )$$

where:

$$\frac{{x}_{A 1} ( t ) \text{:}}{{x}_{A 1} \text{:}}$$

value of feature value x1 of person A at time t, mean value of feature volume x1 of person A within time range 0 to T.

Calculation can be made similarly for the person B. Symbol T represents the width of the time in which the data of the frequency exists.

In other words, when R(τ) reaches peak at τ=τ1 in the equation given above, the behavior of the person B at a certain time tends to be similar to the behavior of the person A at the time ahead of that time by τ1. In other words, it can be said that the feature value xB1 of the person B is affected after the time τ1 from the occurrence of the action of the feature value xA1 of the person A.

The value of τ at which this peak appears can be interpreted as representing the kind of influences. When τ is below several seconds, for example, the value represents the influence when the persons meet directly such as nod and when τ is from several minutes to several hours, the value represents the influences in the aspect of actions.

The application server (AS) conducts the procedure of the calculation of the mutual relation for 92 patterns as the number of feature values about the person A and the person B. Furthermore, the application server (AS) calculates the feature value in the procedure described above for the combination of all the members belonging to the organization (all the members as the object of analysis).

The application server (AS) acquires a plurality of feature values about the organization from the result of the mutual relation calculation about the feature values determined as described above. In consequence, one organization feature value can be obtained from one mutual relation formula. When 92 individual feature values exist, 922, that is, 8,464, organization feature values can be obtained for each pair. The mutual relation reflects the influences and relationship of the two members belonging to the organization. Therefore, the organization constituted by the connection of persons can be handled quantitatively by using the value acquired by the mutual relation calculation as the feature value of the organization. The method for acquiring the organization feature value from the result of the mutual relation calculation may be those other than the method explained above. For example, it becomes possible to analyze (BMDD) in a diversified manner the changes of the organization from a change for a short time to a large change extending for a long time by dividing a time range into several zones such as one hour or below, one day or below or one week or below, and handling the value of the pair of persons as the feature value of the organization (BMDD).

On the other hand, the application server (AS) acquires (BMDE) the data of quantitative evaluation about the organization (hereinafter called “performance”) from the performance database (PDB). Correlation between the organization feature value and the performance is calculated as will be described later. The performance may be calculated from the degree of achievement each person declares or a subjective evaluation result about the human relation in the organization, for example. The financial evaluation of the organization such as sales and loss may be used as the performance, too. The performance is acquired from the performance database (PDB) of the organization dynamics data collection (BMB) and is handled as a pair with the time information at which the performance is evaluated. Explanation will be hereby given on the case where six factors, that is, sales, customer satisfaction, cost, error ratio, growth and flexibility (P1 to p6) are used as the performances of the organization by way of example.

The application server (AS) analyzes the correlation between the organization feature value and the individual organization performance (BMDF). However, large quantities of organization feature values exist and contain unnecessary feature values. Therefore, the application server (AS) selects only effective values as the feature values (BMDG) by a step-wise method. The application server (AS) may select the feature values by methods other than the step-wise method.

The application server (AS) decides (BMDH) a coefficient of correlation A1 (a1, a2, . . . am) that satisfies the following formula regulating the relation between organization feature values x1, x2, . . . xm and the organization performance p:

p₁=a₁X₁+a₂X₂+ . . . +aₘXₘ (Expression 2)

Incidentally, m is 92 in the example shown in FIG. 7C. This calculation is carried out for p1 to p6 and A1 to A6 are decided for p1 to p6, respectively. Modeling is hereby made by the simplest linear system but the values of X1 and X2 can be inputted by a non-linear model to improve accuracy. Alternatively, means such as a neural network can be used, too.

Six performances are anticipated next from the acceleration data by using these coefficients of correlation A1 to A6.

Organization activity analysis (BME) in FIG. 7B is a processing for determining the relationship of persons from acceleration, sound, meeting, etc, about arbitrary two persons in the combination table and calculates the performances of the organization. The organization activity analyzing unit acquires the coefficient of correlation from the correlation coefficient learning unit, outputs estimated values of the organization performances on the basis of the coefficients of correlation so acquired, calculates the mutual relation between the two persons on the basis of two sets of data inputted from the mutual data aligning unit and generates data about the distance reflecting the relationship between the two persons on the basis of the correlation.

It becomes thus possible to estimate, and to submit to users, the performances of the organization on the real time basis while data is being acquired, and to urge the users towards a good direction when the estimation result is not good. In other words, feedback can be made in a short cycle.

First, the calculation using the acceleration data will be explained. Acceleration frequency calculation (EA12), individual feature value extraction (EA13), mutual relation calculation (EA14) between persons and organization feature value calculation (EA15) have the same procedure as the acceleration frequency calculation (BMDA), individual feature value extraction (BMDB), mutual relation calculation (BMDC) and organization feature value calculation (BMDD) in the study of the coefficient of correlation. Therefore, their explanation will be omitted. The organization feature value (x1, . . . , xm) is calculated by these procedures.

The application server (AS) acquires (EA16) the organization feature value (x1, . . . , xm) calculated in step EA15 and the coefficient of correlation (A1, . . . , A6) about each performance calculated by the study of the coefficient of correlation (BMD) and calculates a target value of each performance by using them:

p₁=a₁x₁+a₂x₂+ . . . +aₘxₘ (Expression 3)

This value is the estimation value of the organization performance (EA17).

A distance matrix among arbitrary persons determined from the mutual relation values among the persons are used to decide parameters (organization structure parameters) for displaying the organization structure. Here, the term “distance among persons” does not mean a geographical distance but is an index representing the relationship between the persons. For example, the deeper the relation between the persons (the stronger the mutual relation between the persons), the smaller becomes the distance between them. The group in display is decided by executing grouping (EK42) in a tree structure on the basis of the distance between the persons. The grouping unit judges whether or not the pair of the two persons constitutes the group on the basis of the data about the distance. The matrix and the tree diagram in this case are large elements of organization active display (BMF) that will be later described.

Next, the calculation based on the infrared data will be explained. The infrared data contains the information that represents who meets whom at which time. The application server (AS) analyzes meeting history by using the infrared data (E122). The result of analysis becomes an element of the matrix (EK41) representing the distance between arbitrary persons and grouping can be constituted, too.

Next, calculation based on the sound data will be explained. The mutual correlation between persons can be calculated by using the sound data in place of the acceleration data in the same way as when the acceleration data is used as explained already. However, a conversation feature value can be extracted (EV33), too, by extracting the feature value of the speech from the sound data (EV32) and analyzing the feature value in combination with the meeting data. The conversation feature value is the quantity representing the tone of the voice of the sound, the rhythm of the exchange or the balance of conversation. The balance of conversation represents whether one of the two persons speaks one-sidedly or both speak equally, and is extracted on the basis of the voice of the two persons.

The organization activity that cannot be analyzed by the acceleration data alone can be analyzed or can be expressed more accurately by using these infrared and sound data.

The organization activity displaying unit (BMF) displays the group in the form reflecting the distance when the two persons constitute a common group on the basis of the judgment result of the grouping unit.

The invention has the function of providing analysis and display using various data and results of analyses described above.

### <Overall Construction of Business Microscope System>

Next, the hardware construction of the business microscope system will be explained with reference to FIGS. 8A to 8D. FIGS. 8A-8D show a block diagram useful for explaining the overall construction of the sensor net system for realizing the business microscope system according to this embodiment. Five kinds of arrows having different shapes in FIG. 8A represent time synchronization, associate, storage of sensing data acquired, data flow for data analysis and control signal, respectively.

The business microscope system includes a sensor node (NN), a base station (GW), a sensor net server (SS), an application server (AS) and a client (CL). Each of their functions is realized by hardware or software or their combinations and a functional block does not always have a hardware entity.

The nameplate type sensor node NN shown in FIG. 8D has a plurality of infrared transceiver units TRIR1 to TRIR4 for detecting a meeting condition of persons, a 3-axes acceleration sensor ACC for detecting the operation of a wearing person, a microphone MIC for detecting the speech of the wearer and surrounding sound, illumination sensors LS1F and LS1B for detecting the front and back of the nameplate type sensor node and a temperature sensor THM that are mounted to the wearing person. These sensors mounted are merely exemplary and other sensors may be used to detect the meeting condition and operation of the wearing person.

In this embodiment, four sets of infrared transceiver units are mounted. The infrared transceiver units (TRIR1 to TRIR4) periodically continue to transmit terminal information (TRMD) as unique identification information of the nameplate type sensor node (NN) in a front surface direction. When a person wearing other nameplate type sensor node (NNm) is positioned on a substantial front surface (front surface or obliquely front surface, for example), the nameplate type sensor node (NN) and other nameplate type sensor node (NNm) exchange the respective terminal information (TRMD) through the infrared rays.

Therefore, it is possible to record which person faces which person.

The infrared transceiver unit generally comprises the combination of an infrared light emitting diode for infrared transmission and an infrared photo transistor. The infrared ID transmitting unit IrID generates TRMD as its own ID and transfers it to the infrared light emitting diode of the infrared transceiver module. In this embodiment, since the same data is transmitted to a plurality of infrared transceiver modules, all the infrared light emitting diodes are turned on simultaneously. Needless to say, the data may be transmitted at independent timings or other data may be outputted.

The data received by the infrared photo transistor of the infrared transceiver unit is subjected to exclusive OR operation by an OR circuit (IrOR). In other words, the data is recognized as ID by the nameplate type sensor node as long as at least one infrared receiving unit receives the ID light. A construction that independently has a plurality of reception circuits of the ID may of course be employed. In this case, since the transceiver state can be grasped for the respective infrared transceiver module, additional information such as where-about of other facing nameplate type sensor node can be acquired.

The physical value detected by the sensor is stored in storage unit STRG by the sensor data storage controlling unit. The physical value is processed by a wireless communication control TRCC into a transmission packet and is transmitted by the transceiver unit TRSR to the base station GW.

At this time, it is a communication timing controlling unit TRTMG that takes out the physical value SENSD from the storage means STRG and generates the timing for wireless transmission. The communication timing controlling unit TRTMG has a plurality of time bases for generating a plurality of timings.

The data stored in the storage means include the physical value CMBD built up in the past and data FMUD for updating firm-ware as an operation program of the nameplate type sensor node besides the physical value SENSD detected at present by the sensor.

The nameplate type sensor node detects connection of an external power source EPOW by an external power source detection circuit PDET and generates an external power source detection signal PDETS. Means TMGSEL for switching the transmission timing generated by the timing controlling unit TRTMG or means TRDSEL for switching data wireless communicated is a construction unique to the invention. As a construction in which two time bases, that is, a time base 1 (TB1) and a time base 2 (TB2) are switched by the external power source detection signal PDETS, a construction in which data communicated is switched by the external power source detection signal PDETS from the physical value data SENSD, the physical value CMBD built up in the past and firmware updating data FIRMUPD is shown in the drawing.

The illumination sensors LS1F and LS1B are mounted to the front and back of the nameplate type sensor node, respectively. The data acquired by LS1F and LS1B are stored in the storage means STRG by the sensor data storage controlling unit SDCN and at the same time, are compared by an inside-out detecting unit FBDET. When the nameplate is fitted correctly, the illumination sensor LS1F mounted to the front surface receives incoming external light and the illumination sensor LS1B mounted to the back does not receive this external light because it is sandwiched between the main body of the nameplate type sensor node and the wearing person. At this time, illumination detected by LS1F assumes a greater value than illumination detected by LS1B. When the nameplate type sensor node is turned inside out, on the other hand, LS1B receives external light and LS1F faces the side of the wearing person. Therefore, illumination detected by LS1B assumes a greater value than illumination detected by LS1F.

Here, illumination detected by LS1F is compared with illumination detected by LS1B by the inside-out detecting unit FBDET to detect whether or not the nameplate sensor node is turned inside out and is not correctly fitted. When FBDET detects this inside-out of the sensor node, an alarming sound is generated from a speaker SW to warn the wearing person.

A microphone (MIC) picks up sound information. Surrounding environment such as “noisy” or “quiet” can be known from the sound information. Furthermore, face-to-face communication can be analyzed as to whether the communication is vigorous or stagnant, whether conversation is made equally or unilaterally or whether the persons are angry or laughing by acquiring and analyzing the sound of the persons. The meeting condition that cannot be detected by the infrared transmitter/receiver (TRIR) owing to the standing positions of the persons, etc, can be supplemented by the sound information and the acceleration information.

The speech acquired by the microphone MIC acquires the speech waveform and its integration signal obtained by integrating it by an integration circuit AVG1. The integration signal represents energy of the speech acquired.

The 3-axes acceleration sensor (ACC) detects acceleration of the node, that is, the movement of the node. Therefore, the intensity of the motion and walking of the person wearing the nameplate type sensor node can be analyzed from the acceleration data. Furthermore, liveliness of communication between the persons wearing the nameplate type sensor node, their mutual rhythm and mutual relation can be analyzed by comparing the acceleration values detected by a plurality of nameplate type sensor nodes.

In the nameplate type sensor node, the data acquired by the 3-axes acceleration sensor ACC is stored in the storage means STRG by the sensor data storage controlling unit SCNT and at the same time, the direction of the nameplate is detected by an up-down detecting circuit UDDET. This utilizes the feature of the 3-axes acceleration sensor that two kinds of accelerations, that is, a dynamic acceleration change due to the movement of the wearing person and a static acceleration due to the acceleration of gravity of the earth, are observed in the acceleration detected by the 3-axes acceleration sensor.

When the wearing person has the nameplate type sensor node fitted to the chest, the display device LCDD displays personal information such as the section and the name of the wearing person. In other words, the nameplate type sensor node operates as a nameplate. When the wearing person holds the nameplate type sensor node by hand and directs the display device LCDD towards the own chest, the nameplate type sensor node is turned upside down. At this time, the up-down detection signal UPDET generated by the up-down detection circuit UDDET switches the display content of the display device LCDD and the function of buttons, and the display device LCDD displays the result of analysis by infrared activity analysis (ANA).

When the infrared transmitter/receiver (TRIR) exchanges the infrared rays between the nodes, it is possible to detect whether or not the nameplate type sensor node (NN) faces other nameplate type sensor node (NN), that is, whether or not a person wearing the nameplate type sensor node (NN) meets other person wearing the nameplate type sensor node (NN). For this reason, the nameplate type sensor node (NN) is preferably fitted to the front part of the human body. The nameplate type sensor node (NN) is further equipped with sensors such as the acceleration sensor (ACC) as will be later described. The sensing process in the nameplate type sensor node (NN) corresponds to the organization dynamics data acquisition (BMA) in FIG. 1.

A plurality of nameplate type sensor nodes (NN) exists in most cases and is connected to a base station (GW) nearby, forming a personal area network (PAN).

The temperature sensor (THM) acquires the temperature of the place at which the nameplate type sensor node (NN) exists and the illumination sensor (LS1F) acquires illumination of the nameplate type sensor node (NN) in the front surface direction, for example. Therefore, the surrounding environment can be recorded. The movement of the nameplate type sensor node (NN) from a certain place to another can be known on the basis of the temperature and illumination, for example.

The input/output devices for the wearing person are buttons 1 to 3 (BTN1 to 3), a display device (LCDD) and a speaker (SP).

A recording unit (STRG) is constituted by a non-volatile storage device such as a hard disk or a flash memory and records operation setting (TRMA) such as terminal information (TRME) as a unique identification number of the nameplate type sensor node (NN), the sensing interval and the output content to the display. The recording unit (STRG) can temporarily record data and is used for recording the data sensed. The communication timing control (TRTMG) is a timepiece that keeps the time information and updates the time information in a predetermined cycle. The time information periodically corrects time by the time information sent from the base station (GW) to prevent the error of the time information from other nameplate type sensor nodes.

Sensing control (SDCNT) controls the sensing intervals of various sensors in accordance with the operation setting and manages the data acquired.

Time synchronization acquires the time information from the base station (GW) and corrects the timepiece. The time synchronization may be executed either immediately after associate or in accordance with a time synchronization command transmitted from the base station (GW).

Wireless communication control (TRCC) executes control of the transmission interval and conversion to a data format suitable for the wireless transceiver when the data is transmitted and received. The wireless communication control (TRCC) may have a wire communication function in place of the wireless communication function, whenever necessary. The wireless communication control (TRCC) executes in some cases secondary control lest the transmission timing overlaps with other nameplate type sensor node (NN).

Associate (TRTA) transmits and receives a command for forming a personal area network (PAN) with the base station and decides the base station to which the data is to be transmitted. This associate (TRTA) is carried out when the power source of the nameplate type sensor node NN) is turned on and when transceiver to and from the base station (GW) is cut off as a result of the movement of the nameplate type sensor node (NN). As a result of associate, the nameplate sensor node (NN) is associated with a certain base station (GW) within the range than the wireless signal from the nameplate type sensor node (NN) can reach.

Transceiver unit (TRSR) has an antenna and executes transmission and reception of wireless signals. If necessary, the transceiver unit (TSR) can conduct transmission and reception by using a connector for communication through wires.

The base station (GW) shown in FIG. 8C has the role of relaying the nameplate type sensor node (NN) shown in FIG. 8D and the sensor net server (SS) that is shown in FIG. 8C. A plurality of base stations (GW) are arranged in such a fashion as to cover areas such as private rooms and job sites in view of the reaching distance of wireless signals.

The base station (GW) includes a transceiver unit (BASR), a recording unit (GWME), a timepiece (GWCK) and a controlling unit (GWCO).

The transceiver unit (BASR) receives wireless signals from the nameplate type sensor node (SS) and executes wire or wireless transmission to the base station (GW). The transceiver unit (BASR) further includes an antenna for receiving wireless signals.

The recording unit (GWME) is a non-volatile storage device such as a hard disk or a flash memory.

The recording unit (GWME) stores operation setting (GWMA), data format information (GWMF), terminal management table (GWTT) and base station information (GWMG). The operation setting (GWMA) contains information representing an operation method of the base station (GW). The data format information (GWMF) contains information representing the data format for the communication and information necessary for attaching the sensing data. The terminal management table (GWTT) contains terminal information (TRMT) of the subordinate nameplate type sensor nodes (NN) with which associate can be established at present and local ID distributed for managing these nameplate type sensor nodes (NN). The base station information (GWMG) contains information such as the address of the base station (GW) of its own. The GWME temporarily stores the updated firmware (GWTF) of the nameplate type sensor node.

The recording unit (GWME) may further store a program that is executed by a CPU (not shown) of the controlling unit (GWCO).

The timepiece (GWCK) keeps the time information. The time information is updated in a predetermined cycle. More concretely, the time information of the timepiece (GWCK) is corrected by the time information acquired from NTP (Network Time Protocol) server (TS) in a predetermined cycle.

The controlling unit (GWCO) has a CPU (not shown). As the CPU executes the program stored in the recording unit (GWME), the controlling unit (GWCO) manages the acquisition timing of the sensing data sensor information, processing of the sensing data, transceiver timing to and from the nameplate type sensor nodes (NN) and the sensor net server (SS) and the timing of time synchronization. More concretely, as the CPU executes the program stored in the recording unit (GWME), the controlling unit (GWCO) executes processing such as wireless communication control/communication control (GWCC), data format conversion, associate (GWTA), time synchronization management (GWCD) and time synchronization (GWCS).

Wireless communication control/communication control (GWCC) controls the timing of wireless or wire communication with the nameplate type sensor nodes (SS). The wireless communication control/communication control (GWCC) distinguishes the kind of the data received. More concretely, the wireless communication control/communication control (GWCC) identifies whether the data received is ordinary sensing data or data for associate or response of time synchronization from the header portion of the data and delivers such data to suitable functions, respectively.

Data format conversion (GWDF) looks up the data format information (GWMF) recorded, converts the data to the format suitable for transmission and reception and attaches tag information for representing the data kind.

Associate (GWTA) responds to the associate request sent from the nameplate type sensor node (NN) and transmits a local ID allocated to each nameplate type sensor node (NN). When associate is established, associate (GWTA) executes terminal management information correction (GWTF) for correcting terminal management table (GWTT).

Time synchronization management (GWCD) controls the interval and timing for executing time synchronization and issues a command for executing time synchronization. Alternatively, as the sensor net server (SS) executes the time synchronization management (GWCD), the commands may be collectively sent from the sensor net server (SS) to the base stations (GW) of the entire system.

Time synchronization (GWCS) connects to an NTP server (TS) on the network and requires and acquires time information. The time synchronization corrects the timepiece (GWCK) on the basis of the time information so acquired. The time synchronization transmits the command of the time synchronization and the time information to the nameplate type sensor node (NN).

The sensor net server (SS) manages data collected from all the nameplate type sensor nodes (NN). More concretely, the sensor net server (SS) stores the data sent from the base station (GW) in the database and transmits the sensing data in accordance with the request from the client (CL). The sensor net server (SS) further receives the control command from the base station (GW) and returns the result obtained from the control command to the base station (GW).

The sensor net server (SS) has a transceiver unit (SSSR), a recording unit (SSME) and a controlling unit (SSCO). When time synchronization management is carried out by the sensor net server (SS), the sensor net server (SS) needs a timepiece, too.

The transceiver unit (SSSR) carries out data transmission and reception with the base station (GW), the application server (AS) and the client (CL). More concretely, the transceiver unit (SSSR) receives the sensing data sent from the base station (GW) and transmits this sensing data to the application server (AS) or to the client (CL).

The recording unit is composed of a non-volatile storage device such as a hard disk or a flash memory and stores at lease a performance database (SSMR), data format information (SSME), sensing database (SSDB) and terminal management table (SSTT). The recording unit (SSME) may further store the program executed by a CPU (not shown) of the controlling unit (SSCO). Furthermore, the recording unit SSME temporarily stores the updated firmware (GWTF) of the nameplate type sensor node stored by the terminal firmware registration means (TFI).

The performance database (SSMR) is a database for storing the evaluation (performance) about the organization and the individuals inputted from the nameplate sensor node (NN) or from the existing data together with the time data. The performance database (SSMR) is the same as the performance database (PDB) shown in FIG. 1. The performance is inputted from a performance inputting unit (MRPI).

The data format information (SSME) records the data format for communication, a method for isolating the sensing data to which a tag is attached by the base station (GW) and recording the data to the database, and a method for coping the data request. This data format information (SSME) is always looked up after data reception and before data transmission and data format conversion (SSDF) and data isolation (SSDS).

The sensing database (SSDB) is a database for storing the sensing data acquired by each nameplate type sensor node (NN), the information of the nameplate type sensor node (NN) and the information of the base station (GW) through which the sensing data transmitted from each nameplate type sensor node (NN) passes. Columns are created for the data elements such as acceleration, temperature, and so forth and data are managed. A table may be created for each data element. In either case, all the data are associated with the terminal information (TRMT) as the ID of the nameplate type sensor node (NN) acquired and the information about the time acquired.

The terminal management table (SSTT) is a table that records which nameplate type sensor node is under the management of which base station (GW). The terminal management table (SSTT) is updated when a new nameplate type sensor node (NN) adds to the management of the base station (GW).

The controlling unit (SSCO) has a CPU (not shown) and controls transmission and reception of the sensing data and recording and takeout to and from the database. More concretely, as the CPU executes the program stored in the recording unit (SSME), the controlling unit (SSCO) executes processing such as communication control (SSCC), terminal management information correction (SSTF) and data management (SSDA).

Communication control (SSCC) controls the timing of communication with the wire or wireless base station (GW), the application server (AS) and the client (CL). Communication control (SSCC) converts the format of the data to be transmitted and received to the data format inside the sensor net server (SS) or the data format specialized for the communication counterpart. Communication control (SSCC) further reads the header portion representing the kind of the data and assorts the data to the corresponding processing unit. Concretely, the data received is allocated to data management (SSDA) and the command for correcting the terminal management information, to terminal management information correction (SSTF). The destination of the data to be transmitted is decided to the base station (GW), the application server (AS) or the client (CL).

Terminal management information correction (SSTF) updates the terminal management table (SSTT) when receiving the command for correcting the terminal management information from the base station (GW).

Data management (SSDA) manages correction/acquisition and addition of data inside the recording unit (SSME). For example, the sensing data is recorded by data management (SSDA) to a suitable column of the database in accordance with the element of the data on the basis of the tag information. When the sensing data is read out from the database, too, a processing for selecting necessary data on the basis of the time information and the terminal information and aligning the data in the time order is executed.

The processing that rearranges and records the data the sensor net server (SS) receives through the base station (GW) to the performance database (SSMR) and the sensing database (SSDB) by data management (SSDA) corresponds to the organization dynamics data collection (BMB) shown in FIG. 1.

The application server (AS) in FIG. 8B analyzes and processes the sensing data. An analysis application automatically activates either upon request from the client (CL) or automatically at a set time. The analysis application sends a request to the sensor net server and acquires necessary sensing data. The analysis application further analyzes the application acquired and returns the analyzed data to the client (CL). Alternatively, the analysis application may keep the analyzed data recorded as such in the analysis database.

The application server (AS) includes a transceiver unit (ASSR), a recording unit (ASME) and a controlling unit (ASCO).

The transceiver unit (ASSR) carries out transmission and reception of data with the sensor net server (SS) and the client (CL). More concretely, the transceiver unit (ASSR) receives the command sent from the client (CL) and transmits a data acquisition request to the sensor net server (SS). The transceiver unit further receives the sensing data from the sensor net server (SS) and transmits the analyzed data to the client (CL).

The recording unit (ASME) is constituted by an external storage device such as a hard disk, a memory or an SD card. The recording unit (ASME) stores a set condition for the analysis and the data analyzed. More concretely, the recording unit (ASME) stores a display condition (ASMP), an analysis algorithm (ASMA), analysis parameters (ASMP), terminal information-names (ASMT), analysis database (ASMD), coefficient of correlation (ASMS) and a combination table (CTB).

Display condition (ASMP) temporarily stores a condition for displaying the request from the client (CL).

Analysis algorithm (ASMA) records a program for executing analysis. A suitable program is selected in accordance with the request from the client (CL) and the analysis is executed by using this program.

Analysis parameter (ASMP) records parameters for extracting the feature volume, and so forth. When the parameter is changed to cope with the request from the client (CL), the analysis parameter (ASMP) is rewritten.

Terminal information-name (ASMT) is a contrastive table of the terminal ID and the name, attribute, etc of the person wearing the terminal. The name of the person is added to the terminal ID of the data received from the sensor net server (SS) if any request from the client (CL) exists. The terminal information-name (ASMT) is looked up to convert the name of the person to the terminal ID and to transmit the data acquisition request to the sensor net server (SS) when only the data of the person matching with a certain attribute is acquired.

Analysis database (ASMD) is a database for storing the data analyzed. The analyzed data is sometimes stored temporarily until it is transmitted to the client (CL). Data analyzed are often recorded in a large scale so that the data analyzed collectively can be freely acquired. This database is not necessary when the data is sent to the client (CL) in parallel with the analysis.

Coefficient of correlation (ASMS) records the coefficient of correlation decided by study (BMD) of the coefficient of correlation. Coefficient of correlation (ASMS) is used for organization activity analysis (BME).

Combination table (CTB) is a table for storing data about a plurality of nameplate type sensor nodes aligned by mutual data alignment (BMC).

The controlling unit (ASCO) has a CPU (not shown in the drawing) and carries out control of transmission and reception of data and analysis of the sensing data. More concretely, as the CPU (not shown) executes the program stored in the recording unit (ASME), various kinds of processing such as communication control (ASCC), analysis condition setting (ASIS), data acquisition request (ASDR), mutual data alignment (BMC), correlation coefficient learning (BMD), organization activity analysis (BME) and terminal information-user inquiry (ASDU).

Communication control (ASCC) controls the timing of communication with the sensor net server (SS) and the client data (CL) by wire or wireless communication. Communication control (ASCC) executes data format conversion and allocation of the data destination in accordance with the data kind.

Analysis condition setting (ASIS) receives the analysis condition set by the user (US) through the client (CL) and records it to the analysis condition (ASMP) of the recording unit (ASME). Analysis condition setting (ASIS) generates a command for requesting data to the server and transmits the data acquisition request (ASDR).

The data transmitted from the server on the basis of the request of analysis condition setting (ASIS) is put in order by mutual data alignment (BMC) on the basis of the time information of the data about two arbitrarily persons. This is the same process as mutual data alignment (BMC) in FIG. 1.

Correlation coefficient study (BMD) is a process corresponding to study of the coefficient of correlation (BMD) in FIG. 1. Correlation coefficient study (BMD) is executed by using analysis algorithm (ASMA) and the result is recorded to correlation coefficient study (ASMS).

Organization activity analysis (BME) is a process that corresponds to organization activity analysis (BME) shown in FIG. 1. The organization activity analysis (BME) is executed by acquiring a coefficient of correlation (ASMS) recorded and using the analysis algorithm (ASMD). The execution result is recorded to the analysis database (ASMD).

Terminal information-user inquiry (ASDU) converts the data managed by using the terminal information (ID) to the name of the user wearing each terminal in accordance with terminal information-name (ASMT). Terminal information-user inquiry (ASDU) may further add information about the section and title of the user. Terminal information-user inquiry (ASDU) need not be executed when it is not necessary.

Client (CL) shown in FIG. 8B inputs and outputs data as a contacting point with the user (US). The client (CL) includes an input/output unit (CLIO), a transceiver unit (CLSR), a recording unit (CLME) and a controlling unit (CLCO).

The input/output unit (CLIO) is a unit that operates as an interface with the user (US). The input/output unit (CLIO) includes a display (CLOD), a keyboard (CLIK) and a mouse (CLIM). Other input/output device can be connected to external input/output (CLIU), whenever necessary.

Display (CLOD) is an image display device such as a CRT (Cathode-Ray Tube) or a liquid crystal display. The display (CLOD) may include a printer, or the like.

The transceiver unit (CLSR) carries out data reception and transmission with the application server (AS) or the sensor net server (SS). More concretely, the transceiver unit (CLSR) transmits the analysis condition to the application server (AS) and receives the result of analysis.

The recording unit (CLME) is constituted by an external storage device such as a hard disk, a memory or an SD card. The recording unit (CLME) records information necessary for plotting such as an analysis condition (CLMP) and plotting setting information (CLMT). The analysis condition (CLMP) records conditions such as the number of members as the analysis object set from the user (US) and selection of the analyzing method. Plotting setting information (CLMT) records information about a plotting position as to what should be plotted at which part of the drawing. Furthermore, the recording unit (CLME) may store a program that is executed by the CPU (not shown) of the controlling unit (CLCO).

The controlling unit (CLCO) has a CPU (not shown) and executes communication control, input of the analysis condition from the user (US) and plotting for the submission of the result of analysis to the user (US). More concretely, the CPU executes the program stored in the recording unit (CLME) and executes processing such as communication control (CLCC), analysis condition setting (CLIS), plotting setting (CLTS) and organization activity display (BMF).

Communication control (CLCC) controls the timing of communication with the application server (AS) or the sensor net server (SS) through wire or wireless communication. The communication control (CLCC) converts the data format and assorts the destination in accordance with the kind of data.

Analysis condition setting (CLIS) receives an analysis condition designated from the user (US) through the input/output unit (CLIO) and records it to the analysis condition (CLMP) of the recording unit (CLME). Here, the period of data used for the analysis, the member, the kind of analysis and parameters for analysis, and so forth, are set. The client (CL) transmits these settings to the application server (AS), requests the analysis and executes plotting setting (CLTS) in parallel.

Plotting setting carries out a method of displaying the result of analysis on the basis of the analysis condition (CLMP) and calculates the position at which the drawing is to be plotted. The result of this processing is recorded to plotting setting information (CLMT) of the recording unit (CLME).

Organization activity display (BMF) plots the analysis result acquired from the application server (AS) and prepares a chart. The organization activity display (BMF) displays at this time the attributes of the person displayed such as the name, whenever necessary. The display result so generated is submitted to the user (US) through the output device such as a display (CLOD).

### <Appearance of Business Microscope Nameplate Type Sensor Node>

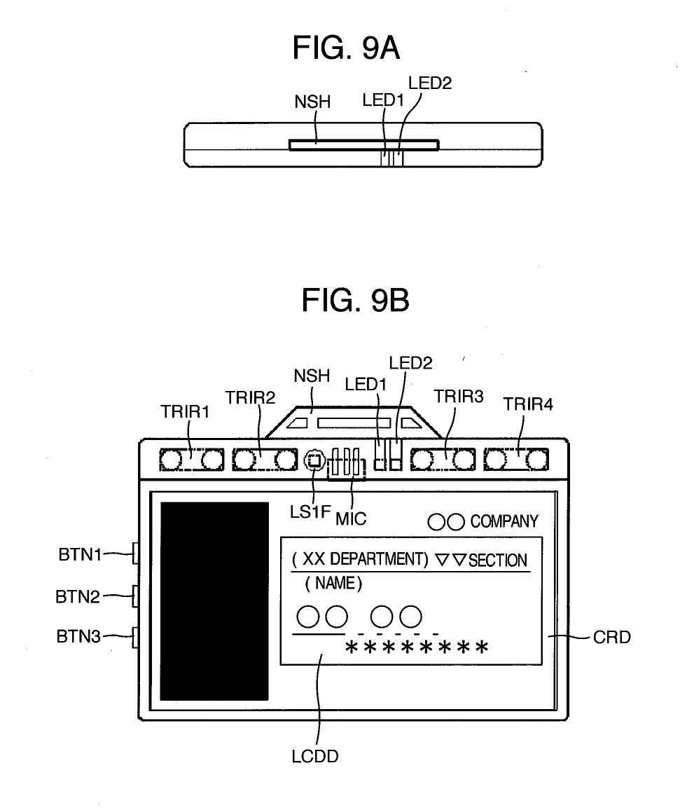

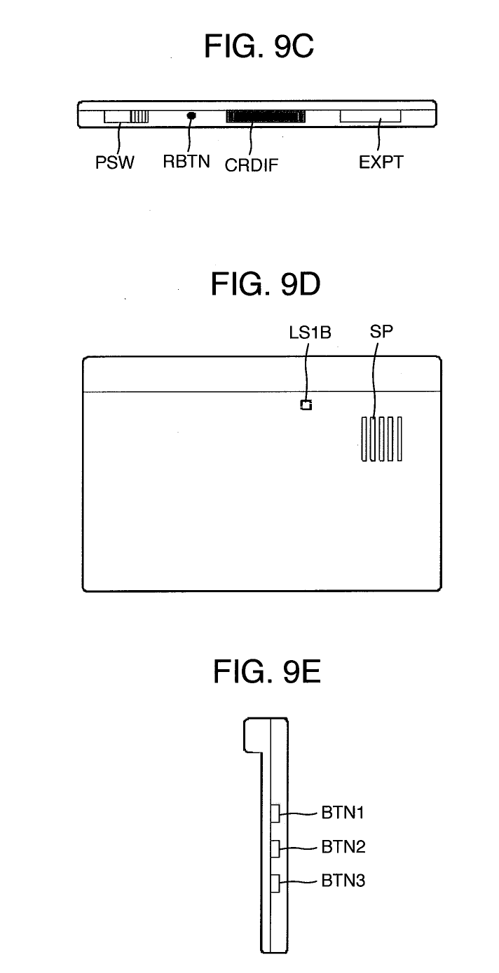

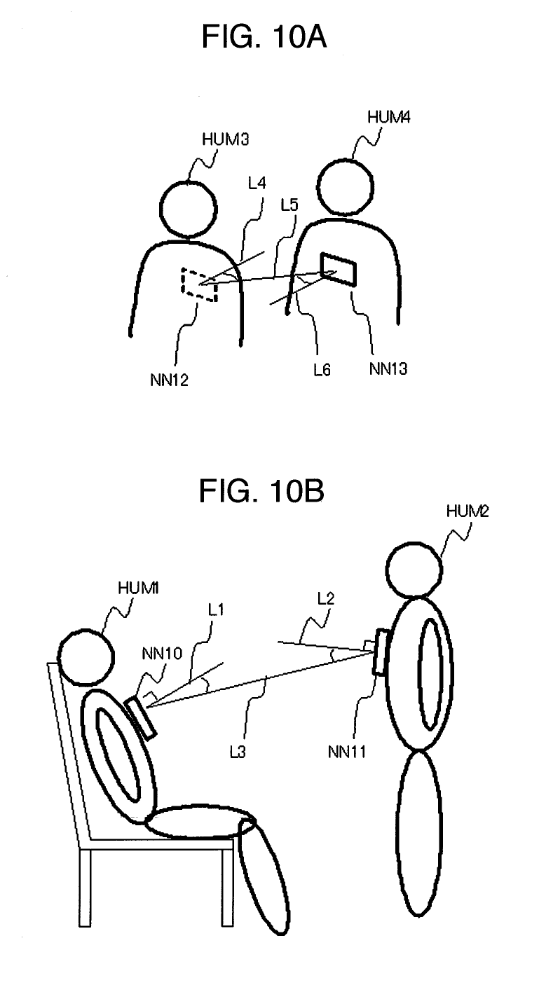

FIGS. 9A to 9E are appearance views when the invention is applied to the nameplate type sensor node and are a top view, a front view, a bottom view, a rear view and a side view, respectively. A neck strap or a clip is fitted to a strap fitting portion NSH and the nameplate type sensor node is used while fitted around the neck or chest of the person.

The surface on which the strap fitting portion NSH exists is defined as “top surface” and a surface opposing the former, as “bottom surface”. The surface facing a mating person when the nameplate type sensor node is fitted is defined as “front surface” and the surface facing the former, as “rear surface”. Furthermore, the surface positioned on the left when the nameplate type sensor node is viewed from the front surface is defined as “left side surface” and the surface facing the left side surface, as “right side surface”.

A liquid crystal display device (LCDD) is arranged on the front surface of the nameplate type sensor node as shown in the front surface view of FIG. 9B. The content displayed on the liquid crystal display device is the display as the nameplate such as the section and the name of the wearing person when the sensor node faces the mating person and the organization activity feedback data for the wearing person when the sensor node faces the wearing person.

The material of the surface of the nameplate type sensor node is transparent so that the card CRD inserted into the sensor node can be seen through the material from outside. The design of the nameplate surface can be changed by exchanging the card (CRD) inserted into the nameplate type sensor.

In the manner described above, the nameplate type sensor node of the invention can be fitted to the person in exactly the same way as the ordinary nameplate and can acquire physical values by the sensor without imparting at all any offensive feeling to the wearing person.

LED lamps LED1 and LED2 are used to report the condition of the nameplate type sensor node to the wearing person of the nameplate and the person facing the wearing person. Light is guided to the front surface and the upper surface of the LED1 and LED2 and the turn-on state can be visually confirmed by both the wearing person and the person facing the former.

The nameplate type sensor node has a built-in speaker SP, which is used to report the condition of the nameplate type sensor node by buzzer and sound to the wearing person and the person facing the former. Microphone MIC picks up the speech of the wearing person of the nameplate type sensor node and the surrounding sound.

Illumination sensors LS1F and LS1B are arranged on the front and back of the nameplate type sensor node, respectively. The inside-out condition of the nameplate type sensor node is detected by the illumination values acquired by LS1F and LS1B and is reported to the wearing person.

Three buttons, that is, BTN1, BTN2 and BTN3, are arranged on the left side surface of the nameplate type sensor node and are used to switch the operation modes of wireless communication and the liquid crystal display screen.

A power switch SW, a reset button RBTN, a cradle connector CRDIF and an external expansion connector EXPT are provided to the lower surface of the nameplate type sensor node.

A plurality of IR (infrared) transceiver units is arranged on the front surface of the nameplate type sensor node. The construction in which a plurality of IR transceiver units is arranged is the one peculiar to the present invention. The construction has the functions of intermittently transmitting the identification number (TRMD) of the nameplate type sensor node itself by IR and receiving the identification number transmitted by the nameplate type sensor node fitted to the mating person. It is therefore possible to record which nameplate sensor node faces which mating sensor node at which time and to detect the facing condition of the persons wearing the sensor nodes. The embodiment shown in FIG. 3 represents an example where four IR transceiver sensors TRIR1 to TRIR4 are arranged at the upper part of the sensor node.

### <Explanation of Arrangement of IR Transceiver Module>

The IR arrangement in this embodiment will be explained with reference to FIGS. 10A to 10C. FIG. 10A shows a positional relationship when two persons HUM3 and HUM4 face and communicate with each other. When the two persons speak to each other, they seldom look each other at front ways. In most cases, their positions deviate from each other by the breadth of their shoulders. In this case, the facing condition cannot be detected if the infrared transceiver units for detecting mutual facing of the nameplates have sensitivity on only the front surface. Sensitivity of about 30 degrees on both right and left sides is necessary with respect to vertical lines L4 and L6 drawn from the surfaces of the nameplates NN2 and NN3 attached to the HUM3 and HUM4, respectively.

FIG. 10B shows a positional relationship when a person HUM1 sitting on the chair and a standing person HUM2 communicate with each other. Because the difference of height exists between the head of the person sitting on the chair and the head of the standing person, the upper half of the body of the person HUM1 sitting on the chair faces somewhat upward. Straight line L3 connecting the nameplate type sensor nodes NN10 and NN11 attached to the HUM1 and HUM2 is positioned below lines L1 and l2 drawn vertically from the surfaces of the respective nameplates. Therefore, both nameplates must have sensitivity in the down direction to reliably detect the facing condition under this condition.

In the embodiment shown in FIG. 10C, the IR transceiver units of the TRIR1 and TRIR4 arranged outside are set to 15° externally in the horizontal direction, and the IR transceiver units of the TRIR2 and TRIR3 arranged inside are set to 15° externally in the horizontal direction and further 30° vertically downward. This arrangement can realize the sensitivity from 45° on the down side of the nameplate to 15° on the up side and 30° in the transverse direction and can reliably acquire the facing conditions between the persons.

### <Procedure of Group Visualization>

Means of organization activity display (BMF) for visualizing the group from the resulting organization dynamics data in the business microscope system described above will be explained. FIG. 1 shows an example of the screen.

As described above, persons face and come into contact with various persons and articles in actual life, social activity and business but these facts are of the kind of information that have not been much perceptible in the past. They are difficult to recall for even oneself to say nothing of others and one may recall if such are information are kept in mind. Therefore, when these kinds of information are built up on the database by the sensors of the sensor network system and the data within a certain period of a time series are looked up, “mutual relation values S” representing which persons as the objects have mutual relationship of to which extent can be obtained. The information for obtaining the S values are the information from the IR sensor for detecting meeting with others by using the IR (EI22 in FIG. 1), the values derived by calculating the correlation data among the persons are diversified such as the data from the acceleration sensor as the information of the motion of the persons (EA14 in FIG. 1), and so forth. The mutual relation value S represents the interaction (relation) between the persons and retrieval of this information is equivalent to seeing of the actual action of the persons.

Here, the mutual relation value S exists in all the pairs (combinations) of the object users and its number can be expressed as Expression 4 where nU is the numbers of users:

$$\frac{nU ( nU - 1 )}{2} \qquad ( Expression 4 )$$

A matrix M of nU×nU shown in FIG. 7 having all these elements is obtained and the mutual relation values S are internally processed as the matrix M. The matrix M is outputted as a distance matrix between arbitrary persons (EK41 in FIG. 7) by the organization activity analysis (BME in FIG. 7). However, the data format dealing with the mutual relation value S is not limited to the matrix format but includes in some cases stroke data and information of the time series.

Next, “true group structure” in which the group structure is clarified by the tree structure is created from the matrix M (EK42 in FIG. 7).

Relation, correlation or connection of people are generally illustrated by using a diagram having a “network structure” and have a hierachical structure (tree structure) shown in FIG. 12B and a loop structure shown in FIG. 12A. In the loop structure, nodes 20 and 21 are connected to each other by a network 21 and to other nodes, forming thereby a loop. Consequently, the loop structure expresses the mode of mutual relation of a plurality of persons and all the nodes may seem equivalent (equal). In the tree structure, on the other hand, nodes 23 and 24 are connected to each other through a network 25, forming a hierachical structure in which “node 24 belongs to node 23”. In this way, the position of the node in the structure and the group structure are clarified and the feature of the node (difference from other node and peculiar position) can be seen.

When the group structure is constituted by large quantities of action data of practical people such as the sensor network, the quantity of data representing the mutual relation is great, too, and almost all the nodes have mutual relation as depicted in FIG. 12A. When this structure becomes great, the structure becomes the one in which the hierachical structure is not much exposed and is difficult to grasp as shown in FIG. 13. Such a problem in which the overall feature is lost and no meaning or value can be recognized in the structure depicted will be called “planarization of network due to frequent occurrence of loop structures”. To solve the problem, it is ideal to express the network by only the tree structure so that the hierachical structure can be seen while the important information volume that large quantities of data have is maintained as such.

To create the tree structure of the relationship from the mutual relation, etc, however, matching is necessary in the parent-child relation shown in FIG. 23A. Assuming that B and C are not parallel but have a relation of master and servant in the relation diagram shown in FIG. 23A, for example, B and C are connected to thereby form the loop structure. Such a phenomenon occurs more frequently with the increase of data and it has been almost impossible to constitute a tree structure having the matching property of the hierarchy (groups) in structures having large quantities of comprehensive data by the existing means.

Therefore, this invention provides means for creating the tree structure T having hierarchy having a direct matching property even from mutually relational matrixes M of large quantities of data. In other words, the invention makes it possible to express the “true group” of people without omission by utilizing complex and large quantities of data of the sensor network system to maximum, that is, the business microscope, that have had difficulty in expressing the groups and hierarchy.

A creation example of the tree structure will be explained concretely. FIG. 33 is a flowchart showing an overall flow of the creation of the tree structure.

First, a group G1 is created from a pair P having a large mutual relation value S as shown in FIG. 14 (100). The pair P always has two nodes (persons, one of matrix elements as shown in FIG. 15). The group and the pair that are expressed as the tree structure are expressed as a diagram in which a node and a node, a group (pair) and a node or a group (pair) and a group (pair) are combined at a certain equal height (called “equal combination”). The height of the position of the combination matches the mutual relation value S between the combination objects. For example, the greater the mutual relation value S in this embodiment, the lower becomes the height of the equal combination to be expressed. The smaller the mutual relation value S, on the contrary, the higher becomes the height of the equal combination to be expressed. Here, the term “group” means an aggregate constituted by a plurality of persons the mutual relationship of which is recognized on the basis of a certain reference and the term “pair”, on the other hand, means an aggregate constituted by two persons irrespective of the existence of the relationship between them. In other words, when the relationship is recognized between the two persons constituting a certain “pair”, the “pair” becomes the “group”.

Subsequently, a pair P having the next greatest mutual relation value S is added to the tree structure (here, group G1) (101). Whether or not the group G1 and the pair P have a shared node Ns is judged (102). When they have Ns, whether or not the group has a hierachical structure is judged (103). The mutual relation value Sa of all the nodes Nall (exclusive of the shared node Ns) of the group that is to be added and the groups that exist already is examined and the mutual relation value Sa is judged as being approximate to a mutual relation value Sb of the existing basic group with a certain threshold value. Furthermore, when the number of groups judged as being approximate exceeds a constant as a threshold value among the total number of groups used for the judgment, the respective groups are connected to the respective pairs and form a group G4 as shown in FIG. 17 and are constituted into a tree diagram Ta having a hierachical structure (104). In this instance, the constant as the threshold value may be a proportion or an absolute value and may be a known value or may be designated arbitrarily by the user or may be determined reversely from the final output result, that is, from the tree diagram T. When finer groups (groups not so rough) are desired to be known, for example, the threshold value is lowered and when a macroscopic observation is made, on the contrary, the threshold value is increased. It is possible to automatically calculate the threshold value that would provide a more apprehensive tree structure without hading over the judgment of the perusal method to the user. Such means can be flexibly decided in accordance with the utilization of the invention and can be provided in the form suitable for the need of the user.

Referring to FIG. 17, for example, since the mutual relation value Sa of Nall is the combination of all the nodes with the exception of A, it is the mutual relation value of B and C. The mutual relation value Sb as the basis is the mutual relation value of A and B of the group G1. When Sa and Sb are judged as being approximate, they undergo equal combination as a group G4 because only one Nall exists and it exceeds a constant number.

When they are not judged as being approximate even when they have the shared node, separate groups are created (105) as shown in FIG. 18 and whether or not the combination is made at the upper layer as a group G3 (106). In FIG. 18, the mutual relation value of A and B is Sb in the same way as in FIG. 17 and the mutual relation value of B and C is Sa. When Sa and Sb are not judged as being approximate, approximation is 0 in 1 as the number of Nall and the value does not exceed a constant number. Therefore, the pair of A and C is grouped into an independent group G2 (105) and is then combined by the group G3 of the mutual relation value Sa (107).

When the group G1 and the pair P do not have the shared node Ns, on the contrary, mutually independent groups G1 and G2 are created as shown in FIG. 16 (108). When they do not have the shared node, judgment is made for the groups G1 and G5 as shown in FIG. 19 (109) and when they are combined, they are combined as a group G6 (110).

In FIG. 19, four Nall exist and the mutual relation value Sa of each of them and the mutual relation value Sb of A and B are judged. When the number of times of judgment as being approximate exceeds a constant value as the threshold value of 4 as the number of Nall, combination is made by the group G6 of the most approximate mutual relation value Sa.

Similar judgment is made for the resulting tree structure with different groups and different pairs and scanning is made in order (111). After scanning of all the pairs is complete, a tree diagram structure T shown in FIG. 20 is obtained as the final output.

The tree diagram T has a hierachical structure and a certain group G8 includes other group G9 and nodes N below it as shown in FIG. 21. In the lowest hierarchy, the group contains two nodes and the inclusion relation of hierarchy finishes in this layer. Accordingly, the tree diagram T (group structure) reflecting the mutual relation values of all the object users can be acquired. The quantity of data of the matrix M of the mutual relation values used increases acceleratedly with the number of users but the afore-mentioned problem “planarization of network due to frequent occurrence of loop structures” does not absolutely occur in the method of the invention but the invention can create the “groups”.

The invention defines first the group (pair) that can be read from the mutual relation value S and builds up the connection and hierarchy for each group. According to the method of the prior art for defining the hierachical structure, the parent-and-child relation, the master-and-servant relation or the connection is first defined for each node and the groups are then illustrated visually. No primary significance exists as to the definition of the “group” and the tree structure relies on subjectivity of the viewing person. Therefore, the invention creates the “group” and makes it distinct as shown in FIG. 22 and constitutes a structure. The information used is relational information having “quantity” as shown in FIG. 23B and the group is made on the basis of this information. The data obtained by the business microscope are diversified and when the values representing the quantitative mutual relations derived from the data by various analyses are used, the users can know the “real groups” that are not known and are made more distinct.

A plurality of nodes representing the same person appears in most cases in the method of the invention and belongs to a plurality of groups. For, the invention uses all the pairs or all the groups as the starting points from the matrix M unlike the existing methods that constitute the tree structure by other information of relationship. For example, a person A assumes that he or she has already had “pairs” with persons other than himself or herself and judges whether the pair appears in the tree structure diagram or in other words, whether or not a certain pair is recognized as a group and appears in the tree diagram T or is combined with other groups. It becomes thus possible to express the state shown in FIG. 5 in which “persons have a plurality of roles by “practical actions and activities of persons” described already. Such a tree diagram correctly expresses the practical organization dynamics that are important for the management of the organization.

As described above, the “true group” in which one person has a plurality of roles, that has been the problem in the past, can be defined as the structure and the structure of the mutual relation of persons can be grasped more macroscopically and more intuitively than the structure using the groups (pairs) as the starting points. Furthermore, when a certain hierarchy is examined, constituent members of the groups and the lower layer groups can be known intuitively.

The tree diagram is prepared in this way by creating and constituting the true groups from the matrix M but in order to illustrate and express more clearly the “groups” as the feature, an organization topographical diagram C shown in FIG. 24 is created.

The organization topographical diagram C has a similar structure to that of the tree diagram T but makes it possible for the users to more readily distinguish the characterizing structure that has not been known by changing the expression method.

First, the problems of the existing diagrams expressing the network structures will be explained. In the existing diagram expressing the network structure, a node 30 is first arranged as shown in FIG. 25 and the intensity of the connection (line) 31 between the nodes is defined by a respective relation value (mutual relation value S used in the invention, for example). The intensity of the connection is expressed in some cases by the thickness of the line or the positions of the nodes are moved to constitute the structure of the mutual relation. This is the same as the problem of “planarization of network due to frequent occurrence of loop structures” described already and is not suitable for clearly expressing the “group” by the method of the invention.

To express the group structure in the invention, nodes (persons) 32 are expressed by a simple figure such as a small circle, a square or a color and a group 33 is expressed in such a fashion as to encompass the nodes 32. This encirclement is the same as the group structure/hierachical structure in the tree diagram T. Therefore, the hierachical structure that is the same as the tree diagram T is expressed by drawing many folds the encircling lines such as drawing a small encircling line inside an encircling line and a smaller encircling line inside the small encircling line. The tree diagram has a feature in its structure constituted by the group starting points to have the feature more easily comprehensible. A portion encompassed by a closed curve (closed loop) corresponds to one “group”. Even when large quantities of nodes and groups exist in mixture, the group can be judged visually comprehensibly by tracing the encircling lines. This is the characterizing feature of this graphical expression unlike the diagrams expressing the existing network structures.

The topographical structure represents the group structure alone. In the invention, all the displays are mapped to a round coordinates system 34 and the node expression and encircling expression described above are made. In this case, the radial distance R from the center in the coordinates of the nodes such as 37 and 38 in FIG. 27B is decided in such a fashion as to match the mutual relation value S of the group of each node in the belonging tree diagram structure (for example, inversely proportionally). In FIG. 27A, a node belonging to the group 37 corresponding to the group 35 having a higher mutual relation value S1 (relatively lower tree height) is mapped to a position close to the center (radial distance R1) and a node belonging to the group 38 corresponding to the group 36 having a numerical value that is not much positive (relatively high tree height) is mapped to a position (radial distance R2) spaced apart from the center. Consequently, positivism inside the group/enclosure of each node/person that has not been fully expressed by the tree diagram expression can be now expressed and the information as to how positive a given node (person) is (negative, though it should be positive) can be intuitively acquired. The overall activities of the organization can be confirmed, too, by macroscopically overlooking the overall circles and discovering the positive nodes (persons) or confirming the existence of small groups that support such positive nodes (persons) and are dispersed around the circumference.

The most fundamental organization topographical diagram C mapped concentrically can be created by conducting the expression described above for all the tree diagrams T.

Operations and expressions can be added to the organization topographical diagram C created from the tree diagrams and various kinds of additional information can be displayed in superposition.

When a mouse cursor is put to the same person who appears at a plurality of positions on the organization topographical diagram C, high-light explanation can be made and the person can draw a specific attention. In other words, the invention can provide the perusal method with the person (node) as the starting point. It is thus possible to easily pay an attention to a specific person and to confirm the person's “position” inside the organization in the organization topographical diagram C in which a large number of nodes appear.

When the node is subsequently clicked, the mutual relation values the person has with other persons/other groups are arranged and displayed in the round form as represented by reference numeral 40. When the person (node) is further grasped at the center and the relation with others is expressed as the distance to the center of the circle, the invention can provide the perusal method with the node positioned closer to the center in the same way as the existing diagrams expressing the network structures. When the cursor is put to a certain group as a macroscopic view, the name and the position of a person can be confirmed and when it is further desired to collate this information with the practical “position”, it is possible to grasp from the mutual relation value at which position the node (person) exists. In this way, it is possible to know the performance or problem of the individual and to conduct a series of management such as feedback to the activities of the overall organization.

It is further possible to overlay or add the information to the organization topographical diagram by using other kind of data such as exchange of e-mails or organization system.

In FIG. 29, information such as the degree of influences between the nodes, directivity of the influences, kinds (exchange of mails, for example), etc can be added by using the information of flow of a certain feature volume for each group.

Still another kind of information (positions in organization in the example shown) can be added by changing the shape of nodes, color expression and pattern as shown in FIG. 30. In the example shown in the drawing, section chiefs are expressed by a square and others, by circles. Therefore, the positions of persons in the office corresponding to the nodes can be imparted by the squares or circles of the nodes.

In the “business microscope” system using the sensor network, this embodiment makes it possible to grasp the “true role” and the “true group” that exist potentially but cannot be grasped positively. Therefore, the business microscope system can be used more effectively as a tool for managing the organization and eventually, management can be made more effectively by acquiring the information has not been grasped in the past.

When the organization is to be managed, effective management can be conducted by merely fitting a small sensor to each person.

The embodiment can provide the effect that the “true group” created and constituted can be known through more intuitive and more sensual expression.

By using the mouse, the user can readily know necessary information from among large quantities of data.

### 2. Embodiment 2

Embodiment 1 represents the sensor net system for visualizing the group on the basis of the relation between the persons. However, the object as the business microscope to which the group visualization system or the sensor net system of the invention is applied is not limited to the relation between the person and the person. For example, when the function of the nameplate type sensor node is built in a clip for bundling a bundle of paper such as distribution documents or circulating documents, the relation between the document and the person or the relation between the document and the document can be visualized in the same way in the office or at a business site.

More concretely, the clip 50 for bundling the bundle 51 of documents (one or a plurality of documents) has a built-in wireless transmission function in the same way as the nameplate type sensor node as shown in FIG. 31 and these clips are collectively and primarily managed in such a manner as to associate persons and sensor values of documents in the same time zone. It becomes thus possible to trace the documents and to discover the relations between persons and documents and between documents and documents that have not been possible in the past.

Large quantities of documents 51 are printed and copied in the office and are distributed and circulated, for example. When the clip sensor node 50 is attached to the documents, the meeting information as to who have “worked out” such documents and who have “looked through” them and the relationship between the person who analyzes the acceleration of the person and the document and the acceleration of the document (degree of synchronization) can be visualized.

In FIG. 32, a person 55 is shown reading a document 54 circulated and the clip sensor node 52 bundling the documents and the nameplate type sensor node 53 acquire this condition. The invention can thus visualize the relation between the document 54 and the person 55.

According to this embodiment, it becomes possible to grasp the relation/correlation between the person and the document and between the document and the documents. Therefore, the business microscope system can be utilized more effectively as a tool for managing the organization and eventually, more effective management becomes feasible by acquiring more latent information relating to persons and persons that has not been able to obtain in the past.

### 3. Embodiment 3

Acceleration data contains great volumes of information as described in Embodiment 1 and means for analyzing the data are diversified, too. For example, acceleration sensor data that have more characterizing features can be collected when a person is walking or sitting or when a person is talking to another or listening. The timing and rhythm at which the change of such characterizing acceleration occurs is calculated by frequency analysis (zero-cross value, FFT, etc). When the rhythm is a high speed rhythm of “3 Hz” as shown in FIG. 40, the person can be characterized as “running” and when the rhythm is a low speed rhythm such as “0.4 Hz”, the person can be characterized as “taking a meal”. In this way, large significance can be imparted to the acceleration information which is otherwise meaningless.

These characterizing activities affect others when the person shares a space with others. For example, when the person “talks to” another as described above, the person who is talked to takes the action of “talking to” the talking person in most cases with a small time interval. Under such a condition, the two persons affect each other and the “degree of mutual influences” can be calculated from the time interval and the number of times and the “direction” of the influences can be calculated from the degree of propagation of the change of the characterizing acceleration. Such power of influence becomes a flow of information and sentiment in the organization and is a value such as “synergy” affecting each other.

The “mutual relation value” between a person and another that is more complicated and more detailed than the meeting information of the infrared rays can be calculated by analyzing the acceleration of a plurality of persons on the basis of the background described above. For example, it is possible to put an arrow on the organization topographical diagram as represented by 41 in FIG. 29 in Embodiment 1 and to allow the arrow to operate as animation. FIG. 34 is an example of such a screen.

More concretely, the analyzing unit of the group visualization system calculates the appearance of the change of characterizing acceleration for each of a plurality of sensor nodes in at least one of the timing and rhythm by analyzing at least one of the zero cross value and the frequency analysis containing FFT and calculates the mutual relation value among a plurality of persons corresponding to the plurality of sensor nodes.

As a result, the degree of influence between the persons and the direction of the influence derived from the acceleration data can be expressed and it becomes possible to understand that the information and the values affect one another and move with respect to one another. For example, the degree of influence is expressed by changing the size of the arrow as shown in FIG. 35 and the direction, frequency and size of the influence can be expressed by animating the color inside the arrow and grasping the speed and frequency.

Consequently, the intensity of “influence power” and its direction covering sharing and transmission of the information between one's superior and a subordinate and their ways of their thinking and actions can be confirmed on the organization topographical diagram. The flow of values, or so-called “value flow”, that has been difficult to perceive and peruse in the past, such as the way of sharing and transmission of information among the persons in the organization topographical diagram, the information as to who is the person having the central force of the organization, the information as to who exerts great influential power though appearing as quite irrelevant, on the contrary, and so forth. It is thus possible by looking up such a “value flow” to confirm whether or not the management operates effectively, and to achieve better management.

### 4. Embodiment 4

Various groups are simultaneously expressed in the organization topographical diagram and their positions and shapes are diversified. When this diagram is viewed as a map having contour lines, the portion exhibiting a characterizing configuration of the ground is in most cases the group to which a specific attention should be paid in the organization.

For example, those portions which swell or are recessed are “capes” and “inlets” in ordinary topographical map and represent that the portions more protrude than the surrounding portions and activities are more vigorous there. The difference of height by the contour line is as such the difference of depth of the hierarchy in the tree structure and has the meaning of the “top” of a mountain, its breast” and “skirt”. For example, the top is the nucleus encompassed a large number of groups and influences are exerted from the top and the skirt is a terminal portion that is affected by these influences and conducts activities while returning sometimes its influences to the top.

It is hereby possible to draw a specific attention to such a characterizing portion by depicting the portion in a color and a style (thickness; solid line or dotted line) that are different from the encompassing line 33 representing the groups 120-123 in FIG. 36.

More concretely, visualization of unknown groups in the group visualization system is the operation that involves the steps of expressing the unknown group by a combination of a plurality of nodes corresponding to a plurality of persons and closed curves encompassing the nodes, expressing the relation between the persons by a distance from a predetermined origin to the closed curve, creating a diagram expressing a portion to be specifically noted by associating a diagram having at least either one of color and style different from those of the closed curve with a specific combination and displaying the diagram so created.

Importance of the degree of attention to the portion can be classified by using properly the color of the encircling line, its thickness and its style. For example, solid line is used to draw a greater attention than dotted line and a similar effect can be obtained by increasing the thickness of the line. For example, encirclement 120 is expressed by dotted line and draws an attention to a relatively broad range and a portion to draw a greater attention inside this enclosure is expressed by an enclosure 121. Different portions are arranged similarly to draw an attention as to 122 and 123.

When a greater organization is analyzed more deeply, the portions to which specific attentions should be paid can be readily known by adding afresh encircling lines in unique colors in the organization topographical diagram in which a large number of groups are dispersed. The business microscope system will be understood and introduced more readily by stressing the advantages and charming points of the organization topographical diagram for those who first see the diagram or those who are to utilize the diagram.

### 5. Embodiment 5

In the organization topographical diagram, the period for analysis and perusal can be changed by changing the period as the object when the matrix is acquired. For example, data during April (April 1st to April 31st) are first looked up and are analyzed to display the organization topographical diagram. Next, the matrix is created from data in subsequent May (May 1st to May 31st) and is displayed in the same way as the organization topographical diagram. These two kinds of topographical diagrams are compared and the change and feature points can be found out.

More concretely, visualization of unknown groups in the group visualization system is the operation that involves the steps of expressing the unknown groups by a combination of a plurality of nodes corresponding to a plurality of persons and closed curves encircling the nodes at a plurality of different points of time, expressing the relation between the persons by a distance from a predetermined origin to the closed curve, and creating and displaying a diagram.

Not only perusal by switching the changes but the persons of the organization and the groups can be expressed like a “chronological table” by plotting the positions of the persons and the groups appearing on the organization topographical diagram onto a graph having a time axis on the abscissa, connecting the plots by one line as represented by reference numeral 124 and adding the expression by colors and thickness. This table is called an “organization chronological table”. FIG. 37 shows an example of the screen.

In this instance, visualization of unknown groups in the group visualization system includes the operation that involves the steps of plotting the positions of the respective nodes and closed curves appearing on the organization topographical diagram onto another diagram having a plurality of different time points on a predetermined coordinates axes, connecting each time point plotted by one line and adding expression of difference by at least one of the color and the thickness to create and display a chronological table of at least one of the persons and the groups of the organization.

As for the persons or groups that come to approach as they have a deep relation value in the topographical diagram in a certain period, lines expressed on the chronological table approach as represented by 128 to 130. It can be understood from the line 128 that a person A and a person B were intimate at the end of July and similarly, the person B and a person C approach on 129 and the person C and a person E approach on 130. The positional relation of the persons or groups on the organization topographical diagram are expressed on the coordinate and it is therefore possible to read that these persons or groups have a deep relation in the period read from the abscissa.

A mark can be put to the starting point or converging point to draw an attention as represented by 125. The point is the one that appears afresh or disappears on the organization topographical diagram and can be said to be a feature point at which the person shows a characterizing movement. For example, a person A and a person E appear from August in the diagram and from this diagram, it is possible to estimate that these two persons start a new project.

It is possible to display encirclement for the groups as represented by 126 and 127. The encirclement is as such the same as the encirclement of the group on the organization topographical diagram. It is further possible to know what position this group exists for what time. Appearance and disappearance of new persons and new groups become obvious exactly as on the chronological table.

Movement of the persons or groups of the organization and movement of the entire organization can be read in various spans along the time series from the organization chronological table. For example, in ordinary chronological table of the history, a famous warlord had close relations with a plurality of local warlords (meeting, circles, rendezvous, etc) and won a large victory through these acquaintances to further grow into greater power. The business microscope can dynamically provide the progress and orbits of persons, groups and projects in the present organizations.

The organization chronological table represents not only the change and transition of the organization along the time series but provides also the effect of “log”. Therefore, it is possible to dynamically read the present change from a similar change of the past and to learn and anticipate the future change.

### 6. Embodiment 6

The invention uses not only the data by the physical sensors but can handle e-mail exchange, other databases and data of PC operations and network logs as the original data as illustrated in Embodiment 1. Concrete examples will be hereby given.

Personal computers (PC) and networks are very important for the organization and management in the present society. Relationship of persons can be found out through the exchange of e-mails and data as to what kind of works the individuals are doing by using the PC can be acquired. For example, it is possible to know what application software the PC uses and to acquire the operation frequency, operation volume and feature of mouse and keyboard and such data can be used as the original data of the business microscope.

Added values can be obtained in addition to the mere object of supervising the constituent members of the organization when such data are combined with the physical sensors (acceleration, meeting, etc).

More concretely, the analyzing unit of the group visualization system acquires data about at least one of the work a person is conducting by using a PC and what application software the PC uses and data about at least one of the operation frequency and the operation volume of at least one of the mouse and the keyboard associated with the PC, combines the resulting data with the sensing data obtained by the physical sensors of the sensor nodes, and analyzes the relation.

For example, under the same state where “a person meets a person A”, it can be estimated that the person is talking to the person A while temporarily facing transversely if both keyboard and mouse do not operate in the PC. When the mouse moves vigorously and the application opening the file of a presentation document is operating, on the contrary, it can be estimated that the person discusses with the person A the content of the presentation document worked out for the next conference if the application opening the file of the presentation document is operating. FIG. 38 shows an example of the screen simultaneously displaying these kinds of information with the meeting information.

The physical sensors can be further furnished with resolution by using the PC and various other data of software in the organization and detailed information as if reflecting a past moment can be provided for perusal.

The output result and the analysis result of the business microscope are expanded not only passively but also positively by using existing network systems (programs and mails) and values can be shared with others to eventually know oneself more deeply. Similar effects can be obtained by putting additional information and remarks to the sensor data and simultaneously displaying them.

Consequently, the business microscope can create and share values with a greater number of people without confining itself in a closed world.

### 7. Embodiment 7

Behaviors of people such as “talking to persons”, “walking at a quick pace”, etc, in a predetermined time zone can be calculated and classified by the timing and rhythm of acceleration derived from the analysis of the zero cross values of acceleration as illustrated in Embodiment 3. Behavior patterns of people can be likewise analyzed and classified by the total time of the meeting time of a person with others, how often a person meets others, etc, in a predetermined time, from the meeting information, too, not only from acceleration. Kinds of such classification are diversified and combinations of the data used and the classification are diversified, too.

When such classifications are expressed in mutually different colors along a time series, the data of the business microscope are aligned like a woven fabric. In this way, a sheet of image table like wallpaper having a broader range of list is outputted. This is called “life tapestry”. FIGS. 39, 41 and 43 represent examples of the screen.

More concretely, the analyzing unit of the group visualization system calculates the occurrence of the change of characterizing acceleration at either one, of both, of the timing and rhythm for a plurality of sensor nodes, by analyzing at least one of the zero cross value and the frequency analysis including FFT, analyzes and classifies the action patterns of a plurality of persons corresponding to the plurality of sensor nodes and generates and outputs a single image by expressing the action patterns of the plurality of persons in mutually different colors continuously along the time series.

The life tapestry looks like a single broad and precise image but when scrutinized by a color or a shape, the action pattern, peculiarity and personal habit of a specific person can be recognized at a glance. When a plurality of persons is simultaneously displayed, the mutual relation, the frequency exerted by power of influences and time difference that are illustrated in Embodiment 3 can be simultaneously recognized.

Embodiment 3 makes it possible to grasp at a glance which person has which influences in the overall structure of the organization and how the value flows but this embodiment provides more detailed and more concrete information.

Assuming that a person A discusses with a person B, their life tapestry continues while exhibiting specific colors, respectively. When examined very carefully, it can be understood that the person B reacts immediately after the person A. It is possible to estimate from this point the tempo and content of the conversation, superior-subordinate relation, and so forth. When the life tapestry of one person is simply and continuously examined, simple and table-like information as a diary such as “played golf all day long”, “sat up till late”, etc, can be provided.

The life tapestry is created from acceleration in FIG. 39 and from meeting information (number of meeting persons, meeting time) in FIG. 41. The color to be expressed is only one variable of acceleration information as in FIG. 39 and colors are simply allocated in accordance with brightness of colors, hue, etc to express distribution. In the case of two variables, e.g. the number of persons and the total time of the meeting information as in FIG. 41, the hue is allocated to the number of meeting persons as shown in FIG. 42 and the total time is allocated to brightness to express distribution. In this instance, since hue changes periodically, the full circumference is not used (leaving non-used portions) in the color distribution by using red for a maximum value and blue for a minimum value, for example. For, the color representing the maximum color and the color representing the minimum value will become the same when the colors are distributed fully to 360 degrees.

In the life tapestry, the abscissa basically represents the time axis but its scale is not primary. This is to improve simplicity as a table by hanging the scale of the time in the period to be perused and changing the magnification. A plurality of persons (person A, person B, person C, . . . ) are aligned on the ordinate for simultaneous comparison or persons are aligned in accordance with specific dates allocated to them (April 1st for person A, April 2nd for person A, April 3rd for person A, . . . ) to compare the same person in accordance with the date. These arrangements can be selected in accordance with the perusal object, that is, whether the entire organization or the individual in the tapestry is to be perused.

It is possible to display for long months by using the abscissa for day-hour. This arrangement makes it possible to look back the past in a longer span.

It should be further understood by those skilled in the art that although the foregoing description has been made on embodiments of the invention, the invention is not limited thereto and various changes and modifications may be made without departing from the spirit of the invention and the scope of the appended claims.

1. A group visualization system comprising:
a sensor network including a plurality of sensor nodes corresponding to a plurality of persons constituting an organization on the 1:1 basis; and
an analyzing unit for analyzing a relation among said plurality of persons from a physical value of each of said persons detected by said sensor network;
wherein unknown groups in said organization are extracted from the relation of said plurality of persons and said unknown groups so extracted are visualized.

2. A group visualization system according to claim 1, wherein said visualization of said unknown groups is an operation that expresses said unknown groups by a combination of a plurality of nodes corresponding to said plurality of persons and a closed curve encircling said nodes and creates and displays a diagram expressing the relation among said persons by a distance from a predetermined origin to said closed curve.

3. A group visualization system according to claim 1, further comprising:
a tree diagram generating unit for generating a tree diagram from the relation of said plurality of persons analyzed by said analyzing unit;
wherein said tree diagram generating unit equally combines and expresses two of said plurality of persons grouped.

4. A group visualization system according to claim 3, wherein the relation of said plurality of persons is expressed in the form of matrix data.

5. A group visualization system according to claim 4, wherein said visualization of said unknown groups is the operation of creating a diagram that expresses said unknown groups by a combination of a plurality of nodes corresponding to said plurality of persons and a closed curve encompassing said nodes and creates and displays a diagram expressing the relation among said persons by a distance from a predetermined origin to said closed curve, and said diagram containing the combination of said nodes and said closed curve and said distance from said origin to said closed curve is generated on the basis of said tree diagram.

6. A group visualization system according to claim 5, wherein the combination of said node and said closed curve corresponds to a combination of nodes equally combined and constituting said tree diagram and said equal combination, and the distance from said origin to said closed curve corresponds to the height of equal combination constituting said tree diagram.

7. A group visualization system according to claim 6, wherein the distance from said origin to said closed curve is smaller when the height of said equal combination is lower, and the smaller the distance from said origin to said closed curve, the stronger the relation among said plurality of nodes encompassed by said closed curve.

8. A group visualization system according to claim 3, wherein, when a first node and a second node are grouped and a third node different from said second node and said first node are recognized as a pair, said tree diagram generating unit recognizes said first node as a shared node, and when the relation between said second node and said third node is greater than a predetermined threshold value, said tree diagram generating unit equally combines a group composed of said first node and said second node with said third node as another new group without recognizing said pair as a group.

9. A group visualization system according to claim 3, wherein, when a first node and a second node are grouped and a third node different from said second node and said first node are recognized as a pair, said tree diagram generating unit recognizes said first node as a shared node, and when the relation between said second node and said third node is smaller than a predetermined threshold value, said tree diagram generating unit recognizes said pair as another new group and equally combines a group composed of said first node and said second node with said another new group to still another new group.

10. A group visualization system according to claim 9, wherein a plurality of groups containing said shared node exists.

11. A sensor network system comprising:
an organization dynamics data acquiring unit including a plurality of sensor nodes having sensors mounted thereto and corresponding to a plurality of persons constituting an organization on the 1:1 basis, acquiring a physical value detected by each of said sensor nodes as data about said plurality of persons and wireless transmitting the data acquired;
a performance inputting unit for inputting performance of each of said plurality of persons to said organization on the basis of a predetermined reference;
an organization dynamics data collecting unit for collecting said data and said performance outputted respectively from said organization dynamics acquiring unit and said performance inputting unit and storing them as a data table and a performance data table, respectively;
a mutual data aligning unit for inputting data about two arbitrary persons among said plurality of persons from said organization dynamics data collecting unit and mutually aligning two sets of data inputted on the basis of time information;
a correlation coefficient studying unit for calculating feature values about said two persons on the basis of said two sets of data inputted from said mutual data aligning unit, calculating an organization feature value as a feature value of said organization on the basis of mutual correlation of said two persons calculated from the pair of said feature values, acquiring organization performance as performance of said organization on the basis of an output from performance database, and analyzing the correlation between said organization feature value and said organization performance and deciding a coefficient of correlation;
an organization activity analyzing unit for acquiring said coefficient of correlation from said correlation coefficient studying unit, outputting an estimation value of the organization performance on the basis of said coefficient of correlation acquired, calculating the coefficient of correlation of said two persons on the basis of said two sets of data inputted from said mutual data aligning unit;
a grouping unit for judging whether or not the pair of said two persons constitutes a group on the basis of said data about the distance; and
an organization activity displaying unit for displaying said group in the form reflecting said distance when said two persons constitute a common group on the basis of the judgment result of said grouping unit.

12. A sensor network system according to claim 11, wherein said organization activity displaying portion displays a diagram expressing said group by a combination of a plurality of nodes corresponding to said plurality of persons and a closed curve encircling said nodes and expresses a mutual relation value containing said mutual relation among said persons by a distance from a predetermined origin to said closed curve.

13. A sensor network system according to claim 11, further comprising:
a tree diagram generating unit for generating a tree diagram from the mutual relation among said plurality of persons calculated by said organization activity analyzing unit;
wherein said tree diagram generating unit equally combines two persons grouped among said plurality of persons and expresses them.

14. A sensor network system according to claim 13, wherein the mutual relation among said plurality of persons is expressed in the form of matrix data.

15. A group visualization system according to claim 1, wherein said analyzing unit calculates the appearance of a characterizing change of acceleration for each of said plurality of sensor nodes in at least one of timing and rhythm through analysis of a zero cross value and frequency analysis containing FFT, and calculates a mutual relation value among said plurality of persons corresponding to said plurality of sensor nodes.

16. A group visualization system according to claim 1, wherein said visualization of said unknown groups is the operation of creating a diagram that expresses said unknown groups by a combination of a plurality of nodes corresponding to said plurality of persons and a closed curve encircling said nodes, expresses the relation among said persons by a distance from a predetermined origin to said closed curve, arranges a graphic having at least one of color and style different from those of said closed curve in association with said specific combination to express a portion to which a specific attention is to be paid, and displays said diagram.

17. A group visualization system according to claim 1, wherein said visualization of said unknown groups is the operation of creating a diagram that expresses said unknown groups by a combination of a plurality of nodes corresponding to said plurality of persons and a closed curve encompassing said nodes at a plurality of different points of time, expresses the relation among said persons by a distance from a predetermined origin to said closed curve, and displays said diagram.

18. A group visualization system according to claim 17, wherein said visualization of said unknown groups includes the operation that plots the positions of said nodes and said closed curve appearing on said diagram to another diagram having said plurality of different points of time arranged on a predetermined coordinates axes, connects each of the points plotted by a single line, applies the expression by the difference of at least one of color and thickness, creates a chronological table of at least one of said persons and said groups of said organization, and displays said chronological table.

19. A group visualization system according to claim 1, wherein said analyzing unit acquires at least one of data as to which work said person is doing by using PC and data as to which application software is used, and data of at least one of operation frequency and operation volume of at least one of mouse and keyboard associated with said PC, combines said data acquired with sensing data acquired by physical sensors of said sensor nodes and analyzes said relation.

20. A group visualization system according to claim 1, wherein said analyzing unit analyzes and calculates the appearance of a characterizing change of acceleration for each of said plurality of sensor nodes in at least one of timing and rhythm through analysis of a zero cross value and frequency analysis containing FFT, analyzes and classifies behavior patterns of said plurality of persons corresponding to said plurality of sensor nodes, and creates and outputs a single image expressing continuously said behavior patterns of said plurality of persons by different colors along a time series.
